(19) United States
(12) Patent Application Publication
(10) Pub. No.: US 2012/0023940 A1
(43) Pub. Date: Feb. 2, 2012

(54) HIGH PERFORMANCE ORC POWER PLANT AIR COOLED CONDENSER SYSTEM

(75) Inventors: Kevin Kitz, Boise, ID (US); Thomas L. Pierson, Sugar Land, TX (US); Stanleigh Cross, Houston, TX (US); Ian Spanswick, York, PA (US)

(73) Assignee: TAS Energy, Inc., Houston, TX (US)

(21) Appl. No.: 13/194,364

(22) Filed: Jul. 29, 2011

Related U.S. Application Data
(60) Provisional application No. 61/369,489, filed on Jul. 30, 2010.

(51) Int. Cl. F03G 4/00; F01K 25/00

(52) U.S. Cl. 60/641.2; 60/671; 60/651

(57) ABSTRACT

An air-cooled condenser system for an Organic Rankin Cycle power plant includes a support structure formed of a plurality of truss members that are coupled together in a spaced apart orientation to horizontally support a plurality of side-by-side condenser bundles. A plurality of fans are likewise supported by the truss members and are disposed above the condenser bundles to draw air across the condenser bundles. Each fan extends over at least two condenser bundles and preferably at least three bundles. An air plenum is provided to establish a minimum separation between each fan and its corresponding condenser bundles so as to fluidly couple each fan to at least two condenser bundles, while at the same time decoupling the air inlet and air exit for the system, thereby minimizing air recirculation.

The present application claims priority to U.S. provisional application Ser. No. 61/369,489, filed on Jul. 30, 2010, which is hereby incorporated by reference in its entirety.

### BACKGROUND

The present disclosure relates generally to industrial, flat-coil, air-cooled heat exchanger systems, and more particularly as an air-cooled condenser system for an Organic Rankine Cycle (ORC) power plant.

Thermal power plants traditionally utilize the Rankine steam cycle to generate electric power. While a variety of modifications have been used in practical applications for improvement of system performance, the basic Rankine cycle 100, illustrated in FIG. 1a, is a closed thermodynamic cycle of which the working fluid experiences at least four stages: evaporation in an evaporator 102 by absorbing heat 104, expansion in an expander 106, such as a turbine, to drive a generator 108 in order to create power, heat exchange in a condenser heat exchanger 110 to release heat and condense the working fluid from a vapor to a liquid, and pump 112 to increase the pressure of the liquid from the condensing pressure (lower pressure) to the evaporator pressure (higher pressure). The working fluid in a Rankine steam cycle is water. An ORC system employs the same principle as a Rankine steam cycle. The difference between these two systems is that an ORC system, which is generally used with a low-temperature heat source, uses an organic working fluid as opposed to water. Selection of the working fluid depends on heat source property, working fluid thermodynamic properties, and operating conditions.

Heat 104 may arise from a number of sources. In traditional power plants, heat 104 is supplied from burning of coal or other fuels. Alternatively, heat may be generated from a nuclear reaction. More recently, heat may be supplied from super heated fluid, such as steam or brine, captured from a geothermal reservoir.

Traditional air cooled heat exchangers, such as air cooled condensers, have been manufactured for many years for use in steam power plants. Such air-cooled heat exchangers typically employ an A-Frame style of construction where a series of fans force air up through two bundles of condenser coils mounted in an A arrangement (as shown in FIG. 1f). For air-cooled condensers used in ORC plants, the prior art has utilized flat condenser coils bundles with multiple, close-coupled fans dedicated to each condenser coil bundle, as illustrated in FIGS. 1b, 1c, 1d and 1e. These ORC air-cooled condensers utilize single-unit, factory-built modules that include a frame 10 supporting a single heat exchanger coil bundle 12 and one or more fans 14 fluidly connected to the coil bundle by a plenum 16. As shown, the fan deck is typically supported below the condenser coil bundle and pushes air through the bundle using forced draft air flow. The fans may also be above the heat exchange coil bundle and draw air through the coils of the bundle in an induced draft configuration. In either configuration, forced or induced draft, these single-unit modules are very heavy since the frame is typically structural steel, the condenser coils, including metal finned tubing, and the plenum are typically constructed of heavy gauge steel. The design and fabrication materials are selected in part to withstand shipping vibration forces for these factory built fan/coil modules. Furthermore, as shown specifically in FIG. 1b, the diameter of the fan/fans is limited to no more than the width of a condenser coil bundle so that the fan/fans and the condenser coil bundle may be shipped as an assembled unit. Moreover the fan/fans are positioned in close proximity to the condenser coil bundle so as to minimize height and weight of the assembly for shipping, and the fan stacks are typically square edged and short such that they provide little aerodynamic efficiency. In addition, the amount of air per square foot of coil face area (coil face velocity) is typically comparatively high so as to minimize the coil surface area required for cooling and thus the number of fans required. While these high velocities reduce cost and improve the “throw” of the hot air exhausted so as to reduce the amount of recirculated air, this high velocity also imposes a high fan power cost. Typically, a plurality of these essentially independent modules are coupled together and supported above the ground by heavy I-beam steel structures in order to allow sufficient airflow circulation. Significantly, this results in the need for many fans, as shown in FIG. 1d, particularly since each fan is typically close-coupled to the condenser coil bundle it serves. More specifically, FIG. 1d illustrates thirty side-by-side coil bundles of the prior art, each bundle having only a single fan across its width and three fans across its length. This particular example may have a bundle width of approximately 14 feet and a length of 60 feet with 3 fans for each bundle. This example shows a total of 30 bundles for an overall plot dimension of approximately 60 feet by 420 feet. In any event, such fans are typically driven by belts 18, which those skilled in the art will appreciate, require significant maintenance to keep correctly tensioned under different operating conditions and which must be replaced at regular intervals. In induced draft configurations, the motor 20 is typically mounted below the coil with two intermediate bearings between the belt 18 and the fan 14. These bearings are another source of maintenance cost to meet recommended lubrication schedules. Furthermore, the close proximity of the fan/fans and condenser coils via a short plenum, results in inefficiencies when hot outlet air from the system is readily drawn back in and recirculates, as illustrated in FIG. 1e, where a front view of a modeled exhaust plenum from the prior art cooler array at 20 mph cross-wind is shown. Such a system reduces the heat exchange capacity of the coils even when considering the rather high face velocities (mentioned above) typically used in the close-coupled design.

More recently, these traditional air-cooled condensers have been utilized in ORC power plants as well. However, those skilled in the art will understand that ORC power plants typically have even larger heat management requirements than traditional steam power plants, thus requiring larger air-cooled heat exchange systems. Thus, as the heat management requirements for these industrial systems continues to grow, drawbacks of the prior art become even more significant and magnified. As an example, geothermal power plants have even larger heat management requirements, given the superheated nature of the geothermal fluids withdrawn from a geothermal reservoir. In such plants, the working fluid may be geothermal steam and/or brine extracted from the geothermal reservoir. An air-cooled condenser system for a geothermal power plant may require 10,000 to over 50,000 sq ft of condenser bundles to meet the cooling needs of the plant. Shipping, constructing and maintaining such an immense system utilizing the bulky, maintenance intensive systems of the prior art is not an optimal solution.

Accordingly, it would be desirable to provide an improved air-cooled heat exchanger system for removal of large amounts of heat in industrial applications, which system reduces air recirculation potential, at the same time reducing capital cost and fan power required for the system. It would also be desirable to reduce the face velocity of the air passing across the coils of such a system while at the same time improving the overall efficiency of the system.

### SUMMARY

These and other objectives are achieved by the system of the invention, wherein an air-cooled condenser system for industrial waste heat management is provided that includes a support structure disposed to horizontally support a fan and at least two side-by-side condenser bundles above the ground. Each fan of the system is mounted above at least two condenser bundles and disposed to induce draft air flow across the two condenser bundles. Preferably, a plenum structure is disposed between each fan and its corresponding at least two condenser coils. The plenum structure is formed of a light weight skin to prevent air ingress except through the coils of the condenser bundles. The height of the plenum is selected to decouple external air flow of the fan from the condenser bundles, maintaining a separation between the air inlet for the condenser bundle and the air outlet of the fan, thereby minimizing recirculation. The support structure is preferably substantially comprised of truss members forming beams, columns, and diagonal components to horizontally support the condenser bundles in a side-by-side relationship, and likewise provide support for the fan unit and the plenum. The support structure as described, as well as the plenum, is lightweight and thus, permits assembly on the system on site at the industrial complex. The plenum and fan design allows much greater spatial separation between the fans and the coils of the condenser bundles than is realized in the prior art. Moreover, this separation permits fewer fans (relative to the prior art) of a larger fan diameter to be fluidly coupled, with internal air flow, with multiple heat exchanger coil bundles.

In one embodiment, an air-cooled condenser system as described above is utilized in conjunction with an Organic Rankin Cycle (ORC) power plant. The overall ORC system includes a pump that is operable to increase the pressure in a liquid organic working fluid, an evaporator that is fluidly coupled to the pump and operable to supply heat to the organic working fluid, an expander system, such as a turbine and generator, that is coupled to the evaporator and operable to expand the organic working fluid and produce useful electrical power or mechanical work, and a heat exchanger that is coupled to the expander and operable to release heat from the organic working fluid, wherein the heat exchanger includes an air-cooled condenser system having a support structure disposed to horizontally support a fan and at least two side-by-side condenser bundles above the ground. Each fan of the system is mounted above at least two condenser bundles and disposed to induce draft air flow across the two condenser bundles. A plenum structure is disposed between each fan and its corresponding at least two condenser bundles to maintain a predetermined separation between the fan and condenser bundles.

In another embodiment, an air-cooled condenser system for an ORC system as described above is utilized in conjunction with a geothermal power plant. The overall geothermal power plant utilizes the geothermal brine to directly release heat from the geothermal brine. The ORC system includes an air-cooled condenser system having a support structure disposed to horizontally support a fan and at least two side-by-side condenser bundles above the ground. Each fan of the system is mounted above at least two condenser bundles and disposed to induce draft air flow across the two condenser bundles. A plenum structure is disposed between each fan and its corresponding at least two condenser coils to maintain a predetermined separation between the fan and condenser bundles.

In another embodiment, an air-cooled condenser system for an ORC system as described above is utilized in conjunction with a geothermal power plant. The overall geothermal power plant includes a separator to separate geothermal steam from geothermal liquid, such as brine, a steam turbine across which the geothermal steam is directed, and an ORC system or systems that is coupled to the steam turbine exhaust and/or the geothermal brine and operable to release heat from the geothermal steam and/or geothermal brine. The ORC system includes an air-cooled condenser system having a support structure disposed to horizontally support a fan and at least two side-by-side condenser bundles above the ground. Each fan of the system is mounted above at least two condenser bundles and disposed to induce draft air flow across the two condenser bundles. A plenum structure is disposed between each fan and its corresponding at least two condenser coils to maintain a predetermined separation between the fan and condenser bundles.

### BRIEF DESCRIPTION OF THE DRAWINGS

FIG. 1a is a schematic view illustrating an embodiment of a Rankine Cycle power system.

FIG. 1b is a top view of a condenser bundle and fan configuration of a prior art air-cooled condenser system.

FIG. 1c is a side view of side view of the prior art air-cooled condenser system of FIG. 1b.

FIG. 1d illustrates thirty side-by-side coil bundles of the prior art, each bundle having only a single fan across its width and three fans across its length.

FIG. 1e illustrates the circulation pattern for a prior art air-cooled system, operating at 20 mph cross-wind.

FIG. 1f illustrates a prior art air cooled condenser for a steam power plant.

FIG. 2a is a perspective view illustrating an embodiment of a support structure for the air cooled condenser system of the invention.

FIG. 2b is a front view illustrating an embodiment of the support structure of FIG. 2a.

FIG. 2c is a side view illustrating an embodiment of the support structure of FIG. 2a.

FIG. 2d is a top view illustrating an embodiment of the support structure of FIG. 2a.

FIG. 3a is a side view illustrating an embodiment of a fan and fan shroud used with the support structure of FIGS. 2a, 2b, 2c, and 2d.

FIG. 3b is a top view illustrating an embodiment of the fan and fan shroud of FIG. 3a.

FIG. 3c is a cut-away side view illustrating an embodiment of the fan and fan shroud of FIG. 3a.

FIG. 4a is a perspective view illustrating an embodiment of a condenser bundle used with the support member of FIGS. 2a, 2b, 2c, and 2d and the fan of FIGS. 3a, 3b, and 3c.

FIG. 4b is a side view illustrating an embodiment of a condenser bundle of FIG. 4a.

FIG. 4c is a front view illustrating an embodiment of a condenser bundle of FIG. 4a.

FIG. 5a is a flow chart illustrating an embodiment of a method for operating an air-cooled condenser system.

FIG. 5b is a perspective view illustrating an embodiment of the condenser bundle of FIGS. 4a, 4b, and 4c supported by the support structure of FIGS. 2a, 2b, and 2c.

FIG. 5c is a front view illustrating an embodiment of the condenser bundle of FIGS. 4a, 4b, and 4c supported by the support structure of FIGS. 2a, 2b, and 2c.

FIG. 5d is a side view illustrating an embodiment of a plurality of the condenser bundles of FIGS. 4a, 4b, and 4c supported by the support structure of FIGS. 2a, 2b, and 2c.

FIG. 5e is a perspective view illustrating an embodiment of the condenser bundle of FIGS. 4a, 4b, and 4c supported by the support structure of FIGS. 2a, 2b, and 2c with a skin coupled to the support structure (but with end skin left off for clarity).

FIG. 5f is a perspective view illustrating an embodiment of the condenser bundle of FIGS. 4a, 4b, and 4c supported by the support structure of FIGS. 2a, 2b, and 2c with a skin coupled to the support structure.

FIG. 5g is a perspective view illustrating an embodiment of a plurality of the fans of FIGS. 3a, 3b, and 3c and a plurality of the condenser bundles of FIGS. 4a, 4b, and 4c supported by the support structure of FIGS. 2a, 2b, and 2c with a skin coupled to the support structure.

FIG. 5h is a cut-away side view illustrating an embodiment of a plurality of the fans of FIGS. 3a, 3b, and 3c and a plurality of the condenser bundles of FIGS. 4a, 4b, and 4c supported by the support structure of FIGS. 2a, 2b, and 2c with a skin coupled to the support structure.

FIG. 5i is a front view illustrating an embodiment of a plurality of the fans of FIGS. 3a, 3b, and 3c and a plurality of the condenser bundles of FIGS. 4a, 4b, and 4c supported by the support structure of FIGS. 2a, 2b, and 2c with a skin coupled to the support structure.

FIG. 5j is a cut-away top view illustrating an embodiment of a plurality of the fans of FIGS. 3a, 3b, and 3c and a plurality of the condenser bundles of FIGS. 4a, 4b, and 4c supported by the support structure of FIGS. 2a, 2b, and 2c with a skin coupled to the support structure.

FIG. 5k is a cut-away top view illustrating an embodiment of a plurality of the fans of FIGS. 3a, 3b, and 3c and a plurality of the condenser bundles of FIGS. 4a, 4b, and 4c supported by the support structure of FIGS. 2a, 2b, and 2c with a skin coupled to the support structure and a support frame coupled to one of the fans.

FIG. 5l is a side view illustrating an embodiment of a plurality of the condenser bundles of FIGS. 4a, 4b, and 4c supported by the support structure of FIGS. 2a, 2b, and 2c, where three condenser bundles are fluidly coupled to one fan.

FIG. 6a is a perspective view of an air-cooled condenser system of the invention.

FIG. 6b is an end view of a modeled air recirculation pattern for an air-cooled system of the invention.

FIG. 6c is a perspective view of a modeled air recirculation pattern for an air-cooled system of the invention.

FIG. 7a illustrates an ORC power plant integrating the air-cooled condenser system of the invention.

FIG. 7b illustrates a geothermal ORC power plant integrating the air-cooled condenser system of the invention.

### DETAILED DESCRIPTION

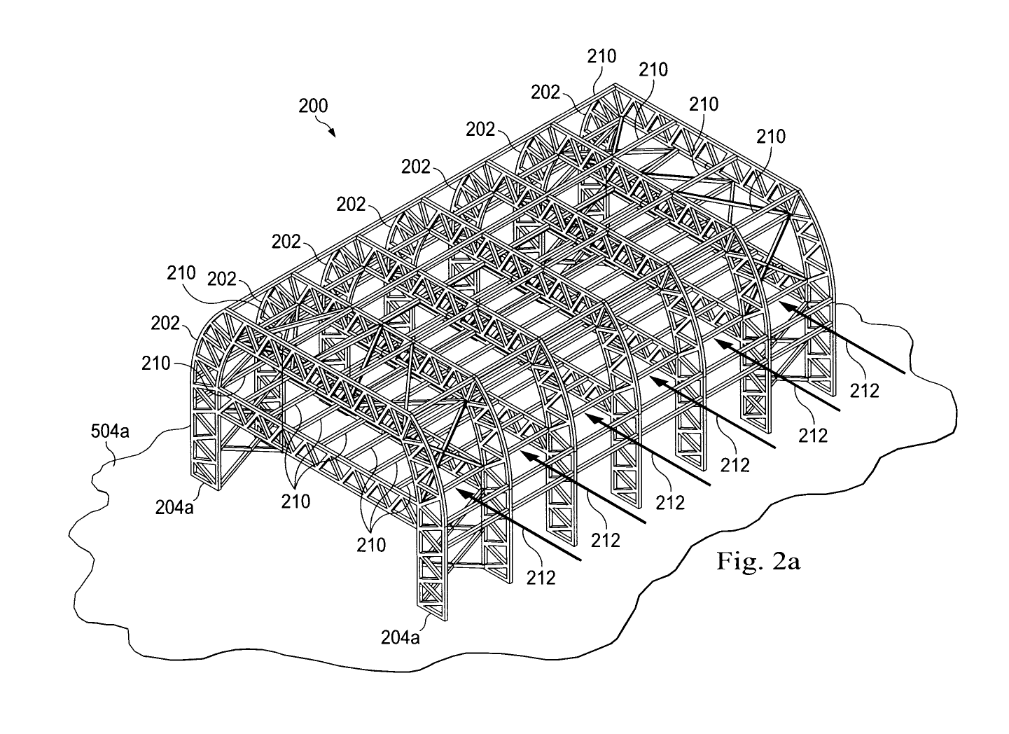

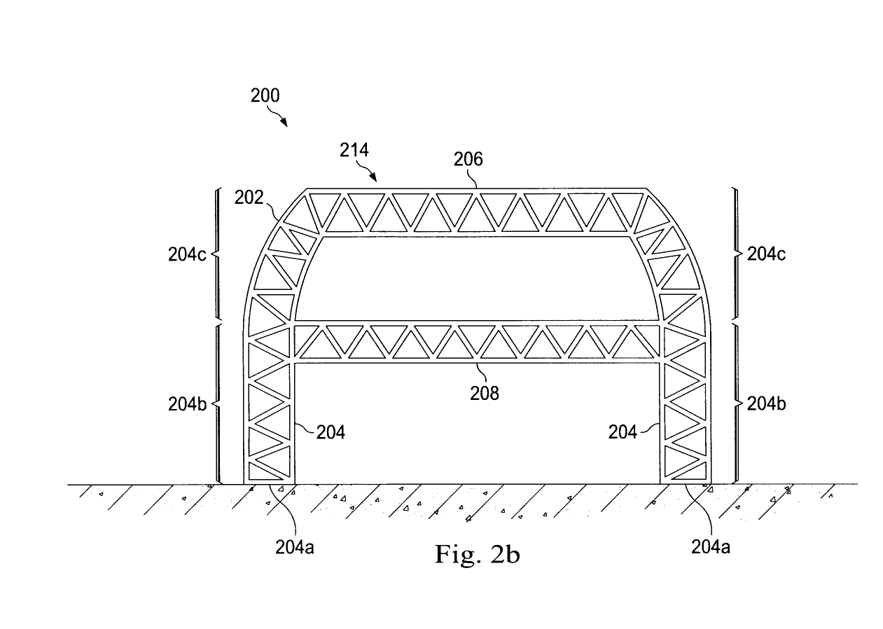

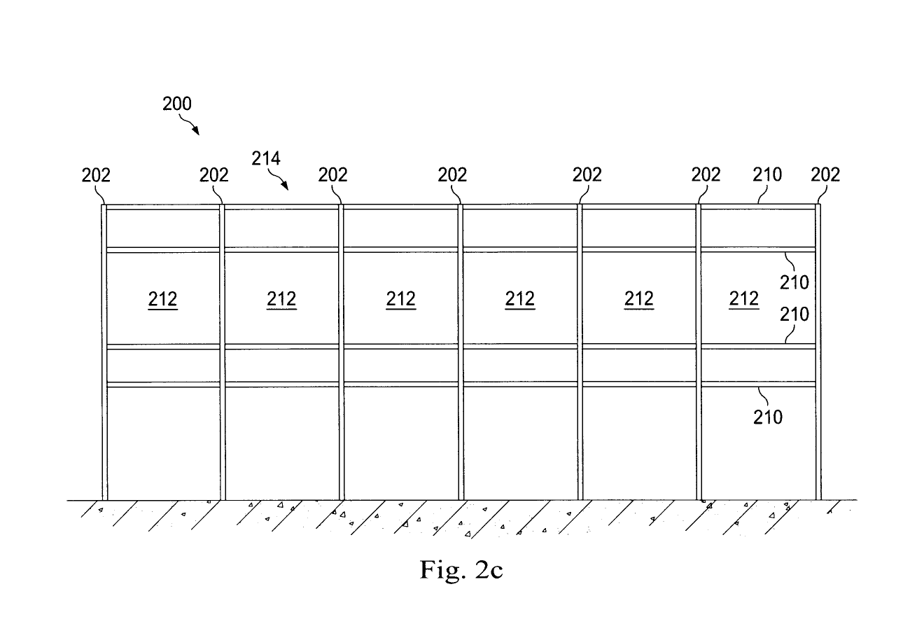

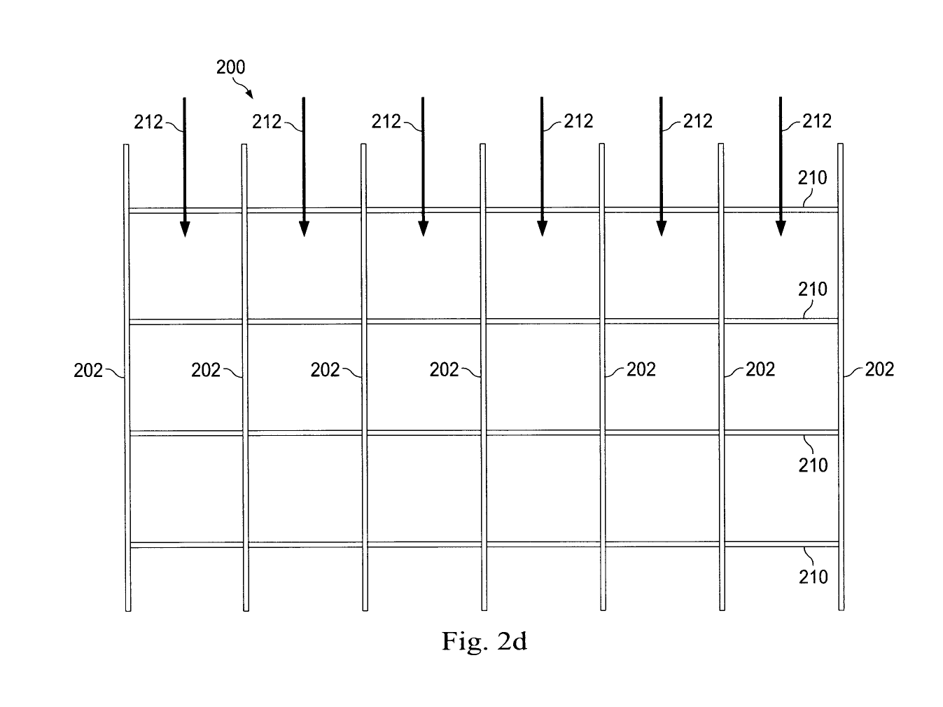

One aspect of the invention is the lightweight structure utilized to support fans and condenser bundles of the air-cooled condenser system. As used herein, bundle is used to refer to a collection or panel of one or more coils arranged to carry a working fluid to be cooled. Referring initially to FIGS. 2a, 2b, 2c, and 2d, such a support structure 200 is illustrated. The support structure 200 includes a plurality of truss members 202. As used herein, a truss is a structure comprising one or more triangulated units constructed with straight and/or curved members whose ends are connected at joints or nodes. Although any type of truss is contemplated by the invention, including planar trusses and three dimensional or space frame trusses, in the illustrated embodiment, each truss member 202 is a planar truss. Support structure 200 is illustrated in FIG. 2b as having side or leg trusses 204, upper trusses 206 and lower or intermediate trusses 208. As best seen in FIGS. 2a and 2b, the plurality of leg trusses 204, upper trusses 206 and lower trusses 208 of the support structure 200 are joined together by a plurality of beams 210.

More particularly, side (or leg) trusses 204 each having a distal end 204a and a straight portion 204b that extends from the distal end 204a. Although not necessary, side trusses 204 may also include an arcuate section 204c that extends from the straight portion 204b. Those skilled in the art will appreciate that arcuate section 204c is simply one preferred embodiment and side trusses 204 could simply comprise straight portion 204b. In any event, respective upper ends of leg trusses 204 are joined by an upper truss 206 that extends between the ends of the arcuate sections 204c. Intermediate truss 208 is disposed to extend between the leg trusses 204 from sections on the leg trusses 204 that are preferably between the distal ends 204a and the ends of the arcuate sections 204c, as illustrated in FIG. 2b, but in any event upper trusses 206 are spaced apart from intermediate trusses 208 a select distance (so as to permit formation of an air plenum as described below). The plurality of intermediate truss members 208 are coupled together by a plurality of beams 210 and held in a spaced apart orientation from each other such that a condenser bundle support structure 212 is defined between any two intermediate truss members 208. Likewise, the plurality of upper trusses 206 and the plurality of beams 210 that extend between the upper trusses 206 form a fan support frame 214. While the truss members 202 have been described and illustrated having specific structures, one of skill in the art will recognize that the truss members 202 may have different structure (e.g., space frame trusses as opposed to planar trusses) and may be coupled together in different manners without departing from the scope of the present disclosure.

Likewise, while a particular shape for lightweight support structure 200 is described, those skilled in the art will appreciate that the particular orientation of components is not intended to be a limitation. For example, support structure 200 need not have an arcuate section 204c. Rather, it is the construction of a support system utilizing a plurality of substantially similar, lightweight truss members for an industrial air cooled condenser and the particular arrangement of condenser bundles and fans that represents one novel aspect of the invention. The support structure as described herein permits comparatively simple, cost-effective, on-site fabrication of an air cooled condenser system, thereby minimizing capital expenditures. This is particularly significant given the size requirements of geothermal power plants, which may require acres of condenser bundles to meet the needs of the power plant.

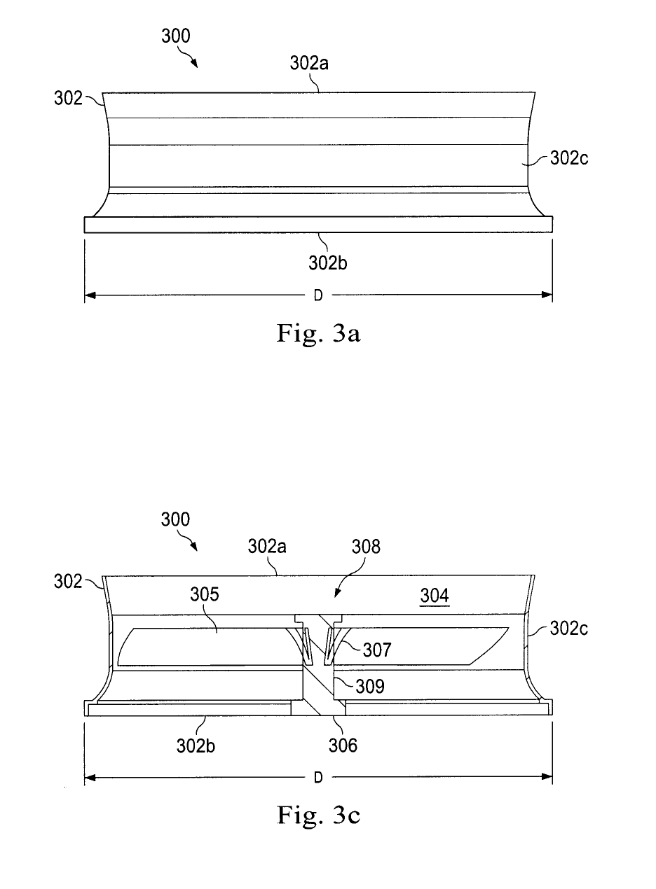

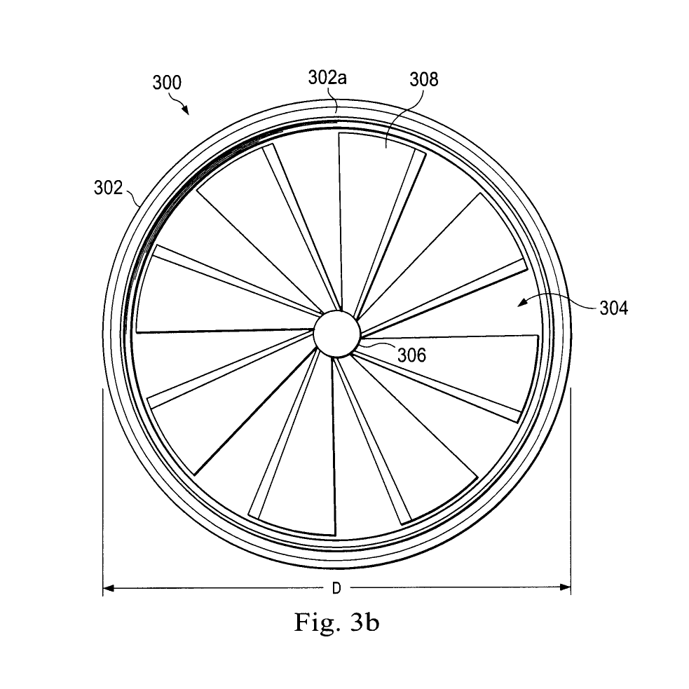

Referring now to FIGS. 3a, 3b, and 3c, a fan 300 is illustrated. The fan 300 includes a fan housing (also called a fan shroud or fan ring) 302 having a top edge 302a, a bottom edge 302b located opposite the fan housing 302 from the top edge 302a, and a side wall 302c that extends between the top edge 302a and the bottom edge 302b. The fan 300 has a diameter D, which is preferably the diameter of the fan housing 302. In an embodiment, the diameter D is at least 12 feet. In another embodiment, the diameter D is at least 20 feet. A fan member cavity 304 is defined by the side wall 302c and located between the top edge 302a, the bottom edge 302b, and the side wall 302c. In the illustrated embodiment, side wall 302c is contoured in order to provide aerodynamic airflow through fan housing 302, and one of skill in the art will recognize that a variety of different contours and overall housing shapes, may be used without departing from the scope of the present disclosure. A fan member 308 is at least partially disposed within the fan member cavity 304. The fan member 308 has a diameter that is approximately the same as the diameter of the fan housing 302 (and therefore the fan 300). Fan member 308 includes one or more fan blades 305 mounted on a hub 307 which is coupled to a spindle 309 driven by a motor 306. Preferably, the fan is a direct drive fan so that the motor 306 is directly linked to the spindle 309, and thus requires less maintenance than belt driven fans. In an alternative embodiment, a gearbox (not shown) may be disposed between the motor and the spindle, so that the spindle 309 is linked via a gear box to the output shaft of the motor 306. In an embodiment, the motor 306 is a variable frequency drive motor that is operable to vary the speed of the fan member 308. The top edge 302a of fan 300 corresponds with the air outlet for the fan (and for the overall air-cooled system), while the bottom edge 302b of fan 300 corresponds with the air inlet for the fan. Preferably the distance between the top edge 302a and the bottom edge 302b is at least three feet. The large fan results in a tall shroud that is centered in over the length of the tubes. This geometry creates the double benefit of increasing vertical separation and horizontal separation from the edge of the top of the shroud to the closest point of intake into the air cooled condenser system. Moreover, it is believed that a velocity recovery cylinder such as fan housing 302 decreases required fan horsepower.

In one preferred embodiment, each fan operates at less than 250 RPMs and has a power output of greater than 25 horsepower and a diameter greater than 15 ft., such operational parameters determined based on the preferred volume of air movement for a fan spanning more than one condenser bundle. In another preferred embodiment, each fan operates at approximately 110 RPMs and has a power consumption of approximately 90 horsepower and a diameter D of approximately 30 ft.

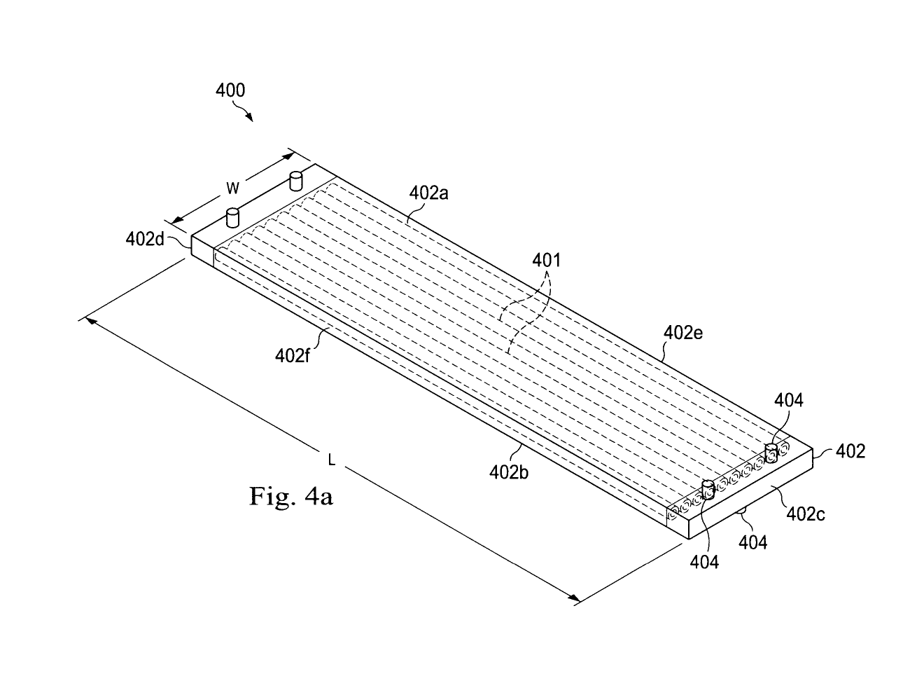

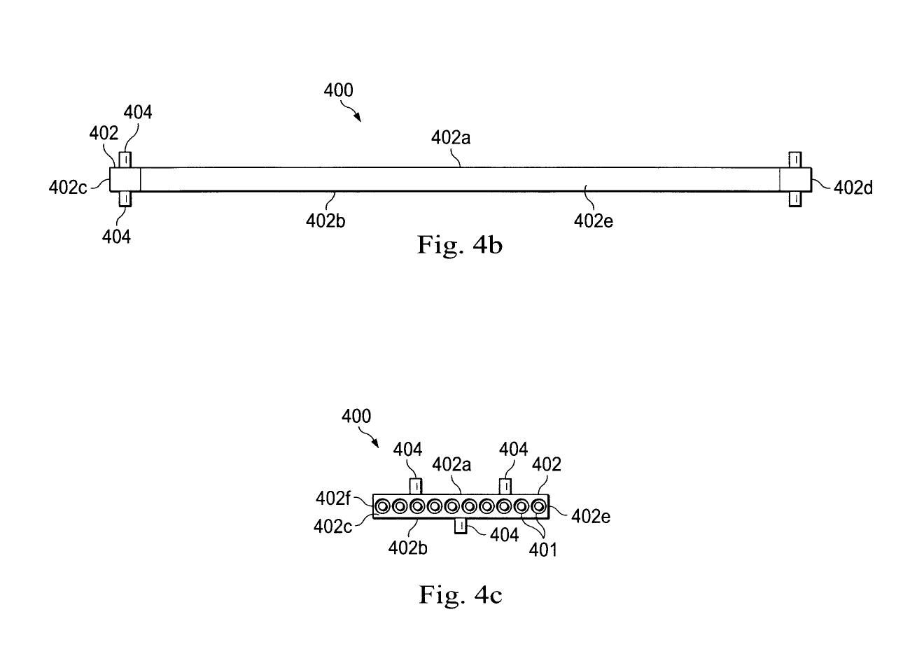

Referring now to FIGS. 4a, 4b, and 4c, a condenser bundle, also referred to as a condenser panel or condenser tube bundle or panel, 400 is illustrated. The condenser bundle 400 includes one or more coils or tubes 401 extending from a header 402. Condenser bundle 400 has a top surface 402a, a bottom surface 402b, a proximal end 402c, a distal end 402d, and a pair of sides 402e and 402f, the surfaces 402a, b; the ends 402 c, d; and the sides 402e, f thereby defining a spread or boundary for coil 401. In an embodiment, the condenser bundle 400 is characterized by a width W that is the shortest distance between the side surfaces 402e and 402f and a length L that is the shortest distance between the ends 402c, d. In one preferred embodiment, the width W is at least approximately 8 feet. In one preferred embodiment, the width W is at least approximately 10 feet. In one preferred embodiment, the length L is at least approximately 40 feet. In one preferred embodiment, the length L is at least approximately 60 feet. In another preferred embodiment, the bundle length L is greater than 40 feet and the bundle width W is greater than 8 feet. Those skilled in the art will appreciate that condenser bundles of the foregoing dimensions are necessary for the industrial waste heat removal contemplated by the invention. In this regard condenser bundles of such a size must be readily and easily supported, which is why the truss system described herein is one aspect of the invention.

Header 402 may include a plurality of inlets and outlets 404 in fluid communication with tube or coil 401. In an embodiment, a plurality of other feature known in the art of condenser bundles may be included on or otherwise form part of condenser bundle 400 but have been omitted for clarity of discussion. In one embodiment, for example, the bundle 400 comprises a multiplicity of coils or tubes 401, preferably substantially extending longitudinally along the length of the condenser bundle 400. In another embodiment, coils 401 may be provided with fins externally mounted thereon. In yet another embodiment, a second header with fluid flow ports may be provided at the distal end 402d of bundle 400 and attached to the coil to permit fluid communication therebetween. The bottom surface 402b of condenser bundle 400 corresponds with the air inlet for the bundle (and for the overall air-cooled system), while the top surface 402a of condenser bundle 400 corresponds to the air outlet for the bundle.

Those skilled in the art will appreciate that the other than orientation of the bundles, the invention is not limited to a particular bundle configuration of coils or tubes, and that the foregoing is only for illustrative purposes in further describing the invention.

As described above, in the preferred embodiment, the fan 300 is disposed to draw air across at least two side-by-side, substantially horizontal condenser bundles 400, and as such, the diameter D of fan 300 is greater than the width W of a bundle 400 such that fan 300 extends across a portion of at least two bundles 400. Preferably the diameter D of fan 300 is at least equivalent to twice the width W of bundles 400. Put another way, diameter D of fan 300 is equal to or greater than twice the width W of bundle 400. In another preferred embodiment, diameter D is equal to or greater than three times the width W, such that fan 300 extends across, and operates to draw air across at least three side-by-side condenser bundles 400. In another embodiment, the diameter D of the fan is greater than 150% of the width W of bundles 400. For the overall system, which may consist of tens or hundreds of fans and an even greater number of condenser bundles, in one preferred embodiment, it is desirable to have a ratio of at least two condenser bundles to each fan, and preferably three condenser bundles to each fan in the system.

With respect to the spacing between the fan 300 and its respective bundles 400, in order to ensure that one fan can draw air across at least two condenser bundles 400, fan 300 is spaced apart from the top surface 402a of condenser bundles 400 by at least 5 feet.

Moreover, in order to minimize recirculation of heated exhaust air into the system, the air outlet for the system at or above top edge 302a of fan 300 is separated from the air inlet for the system at or below bottom surface 402b of condenser bundle 400 by at least 10 feet. In another embodiment, the separation is at least 15 feet, while in another embodiment, the separation is at least 20 feet. Preferably the air inlet and the air outlet are each substantially horizontal to further minimize the likelihood of recirculation.

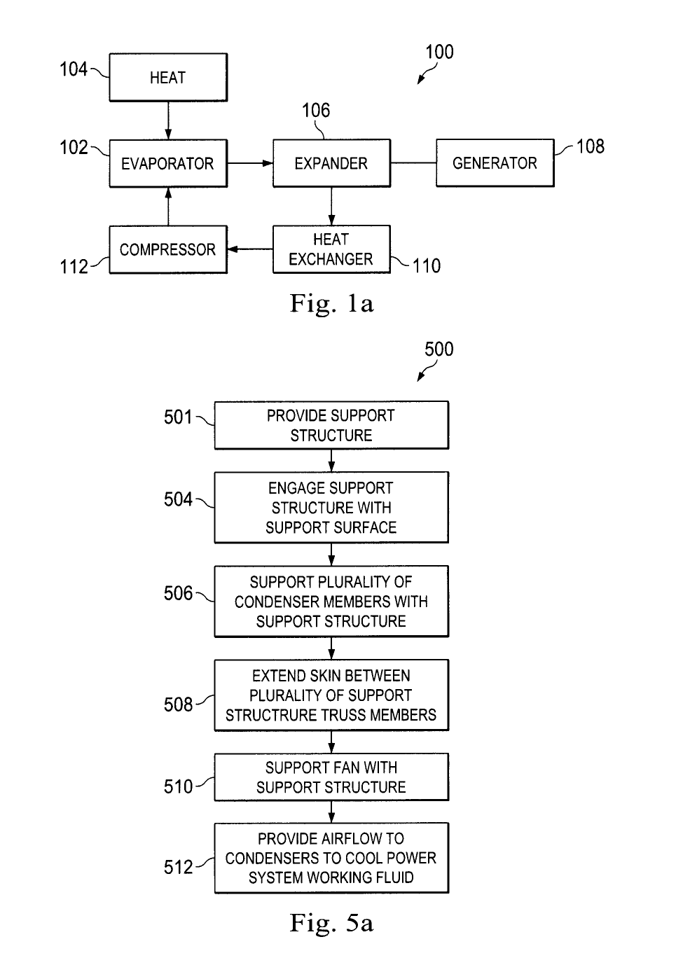

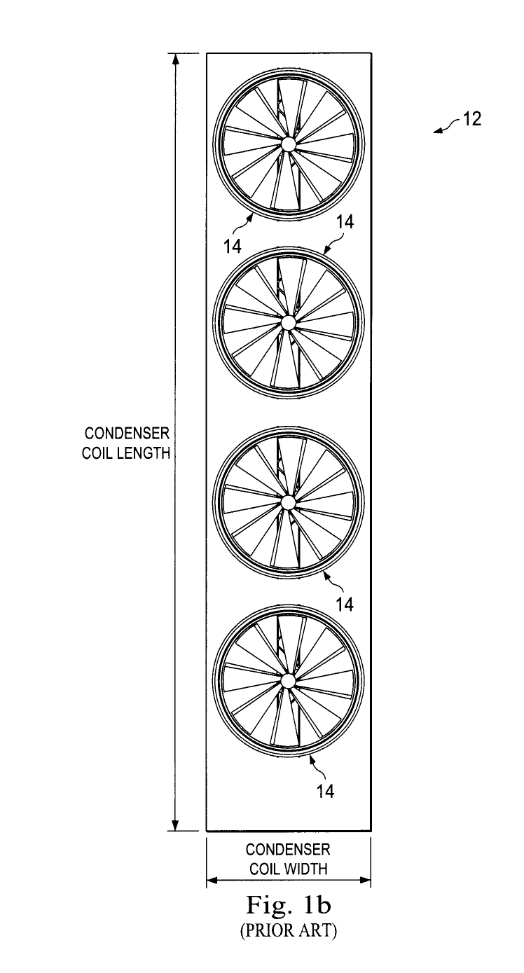

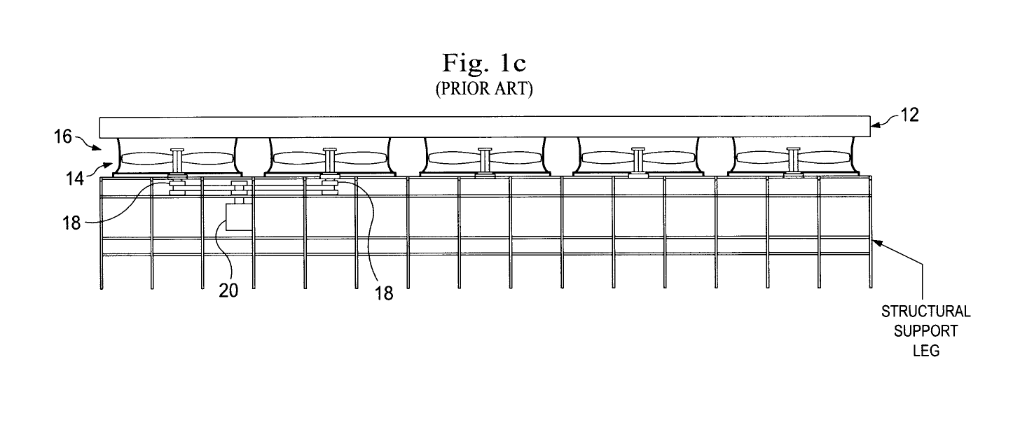

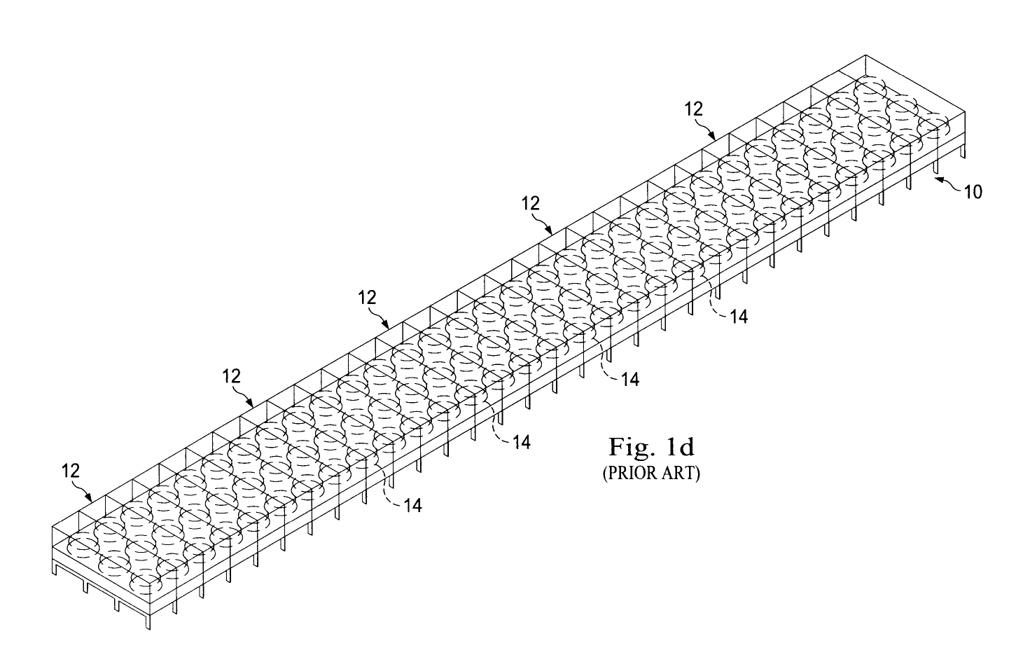

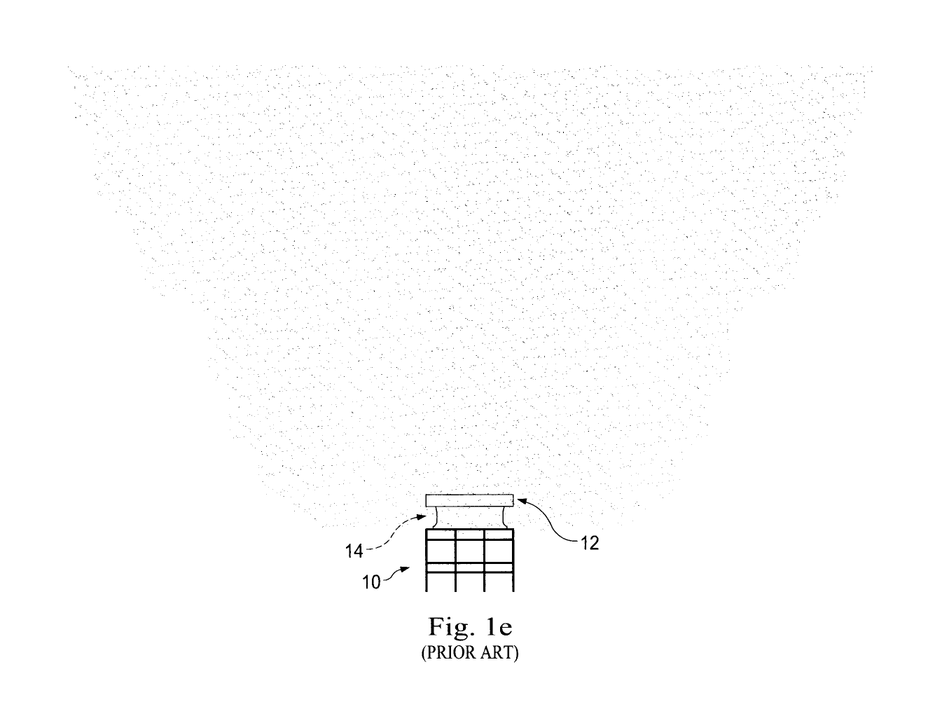

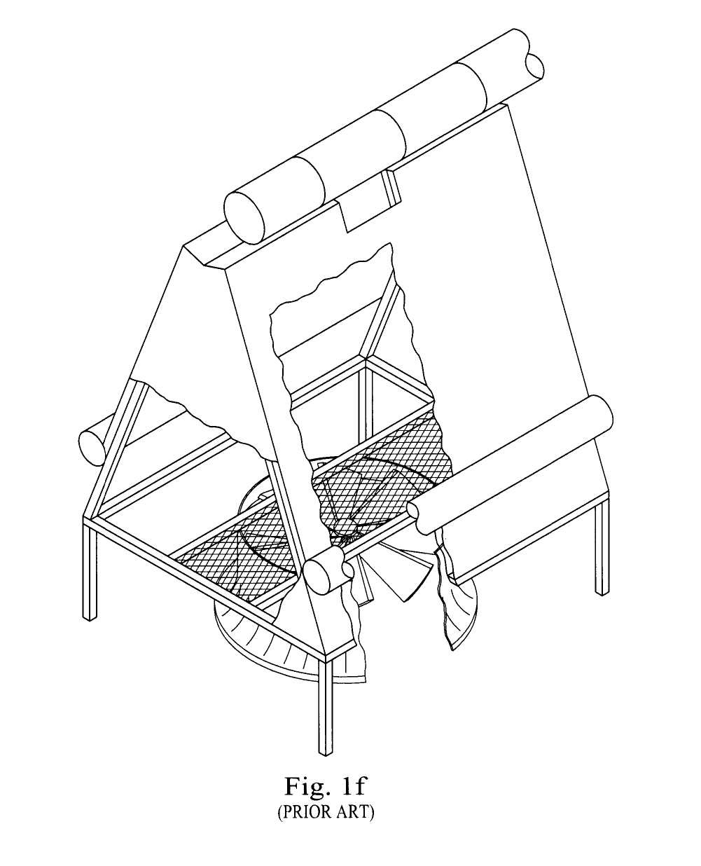

With the air cooled condenser system of the invention, and its respective components, now generally described, certain components and their functional relationships will be more specifically described. Support structure 200 is provided and engaged with a support surface. In one embodiment, the support structure 200, described above with reference to FIGS. 2a, 2b, 2c, and 2d, has leg trusses 204 that are engaged with a support surface 504a (such as the ground or a foundation or footings), as illustrated in FIG. 2a. The support structure 200 may be secured to the support surface 504a using securing methods known in the art. The truss members 202 are preferably prefabricated and substantially similar to each other. Likewise, beams 210 are preferably prefabricated and substantially similar to each other. Prefabrication may provide for couplings on the truss members 202 and beams 210 that allow them to be coupled to each other quickly and easily. Prefabrication also allows the truss members 202 and the beams 210 to be shipped before they are coupled to each other, which lowers shipping costs as they may be stacked and their shipping volume minimized. The truss members 202 and the beams 210 may be shipped to an industrial site before they are coupled together. In one embodiment, the industrial site is a location that includes a power system such as, for example, a power plant. In one embodiment, the power system or power plant may employ a Rankine Cycle or an Organic Rankine Cycle similar to the basic Rankine Cycle 100 described above with reference to FIG. 1 (e.g., the power plant may be an Organic Rankine Cycle geothermal power plant). In the event, the truss members 202 and beams 210 are preferably coupled together “on site” at the power plant to form the features of the support structure 200 described above.

An additional benefit to the support structure 200 format of the truss member 201 is that it minimizes interface with air flow into the system. Given the “open” nature of a truss member, air can readily flow through the member to the air intake.

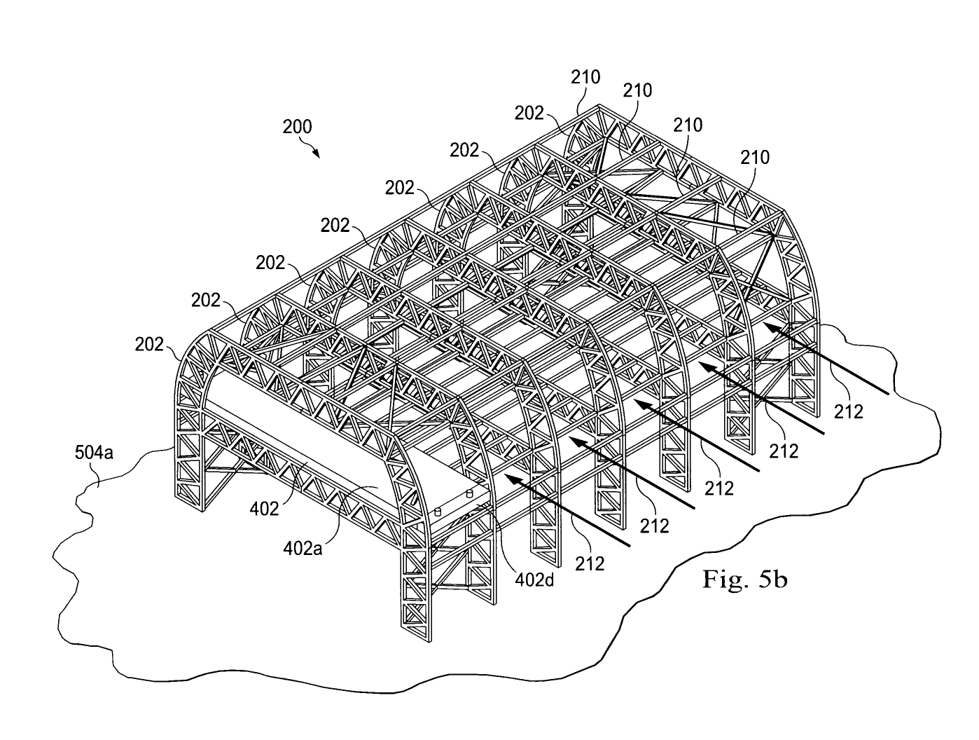

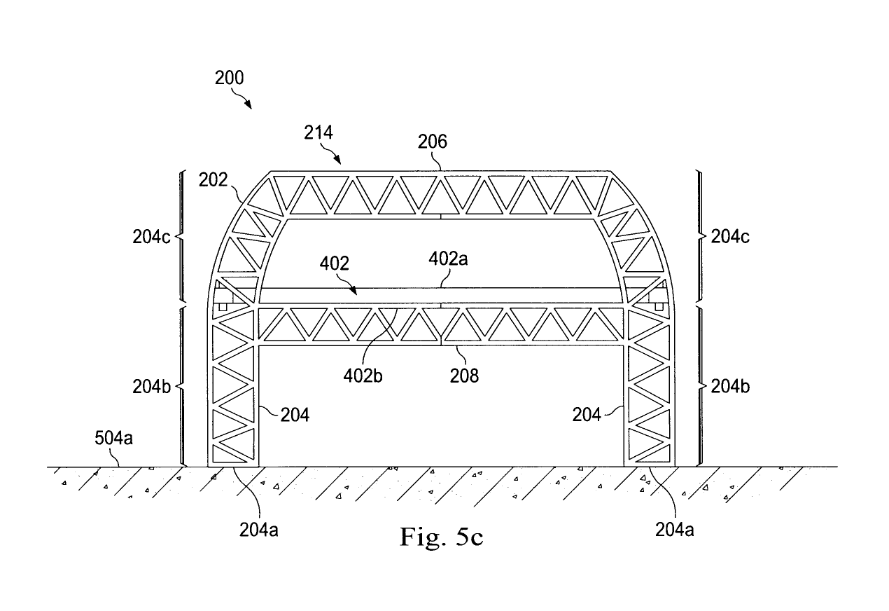

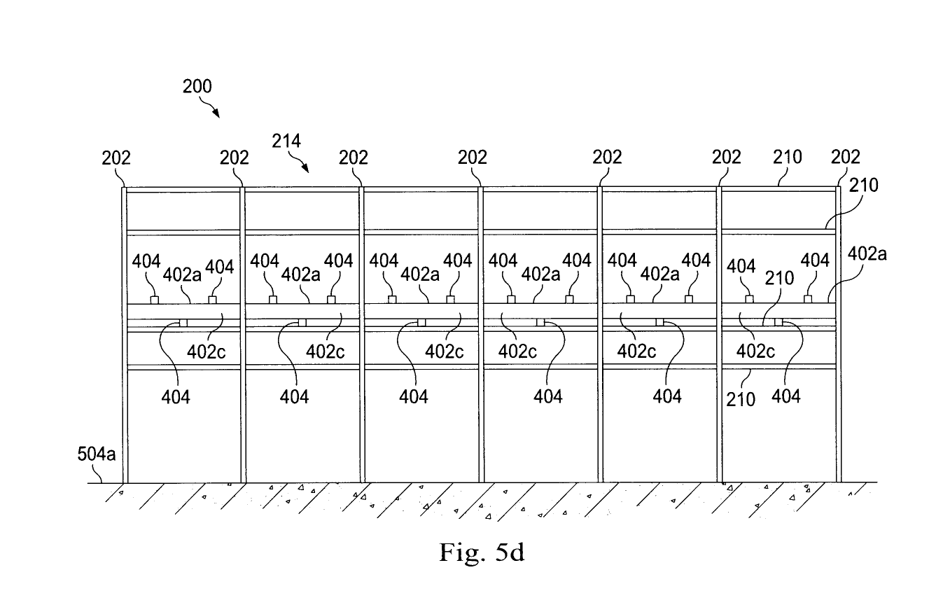

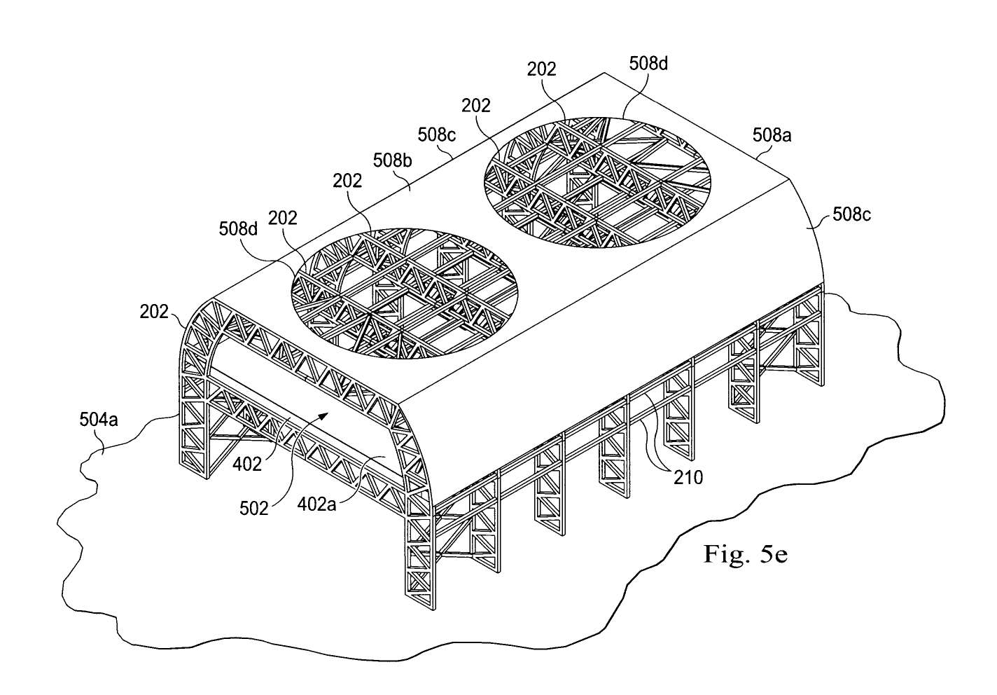

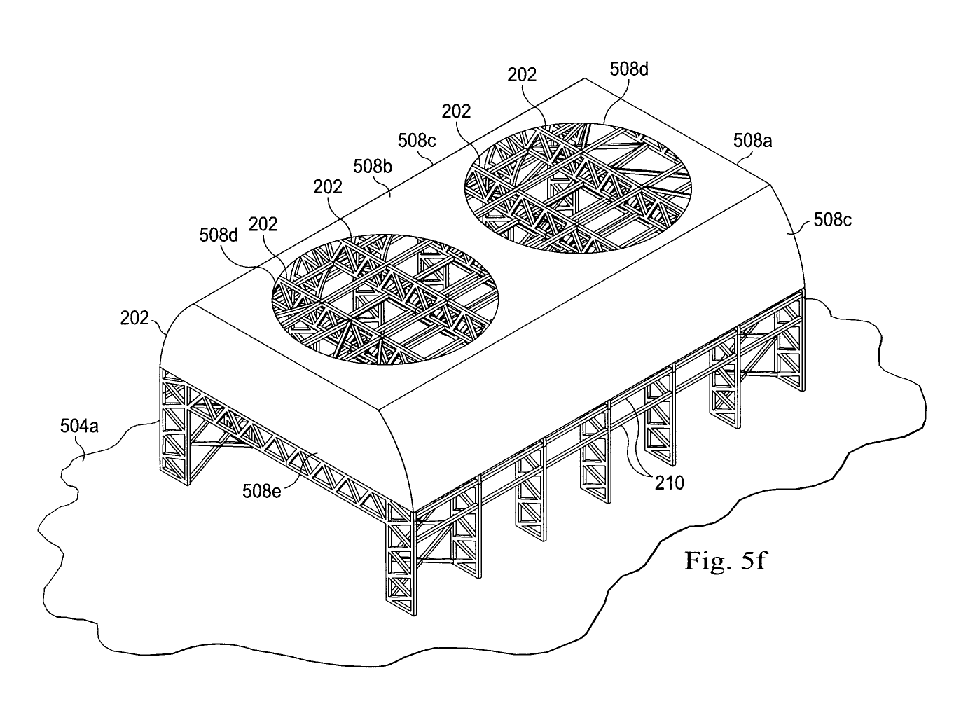

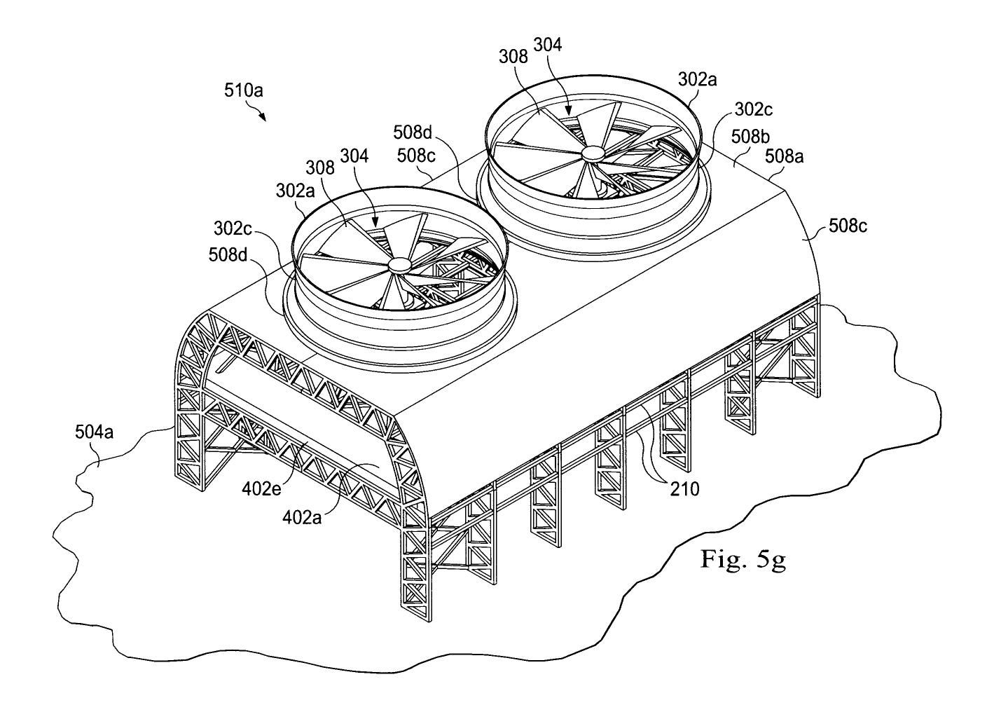

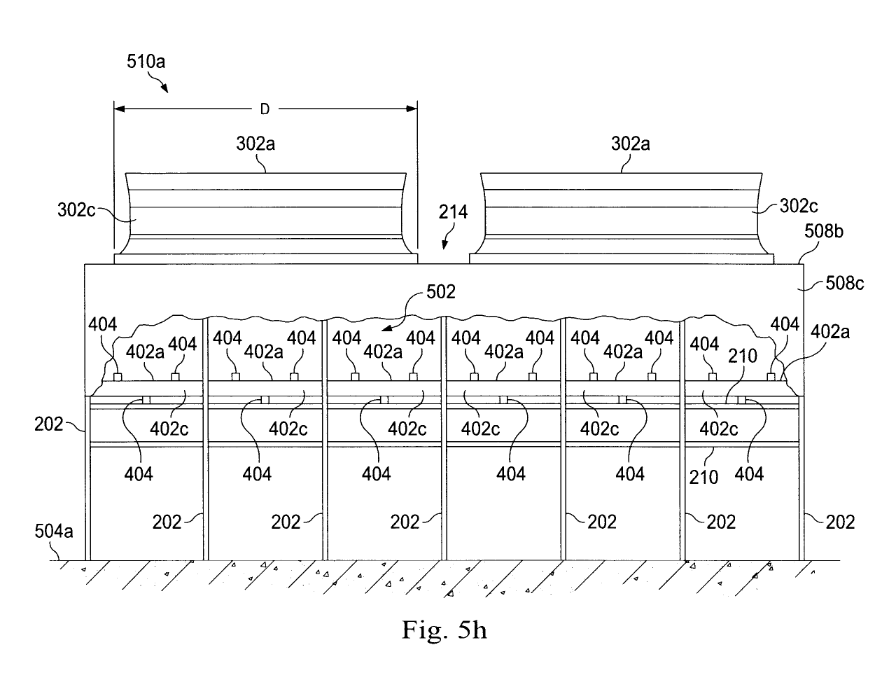

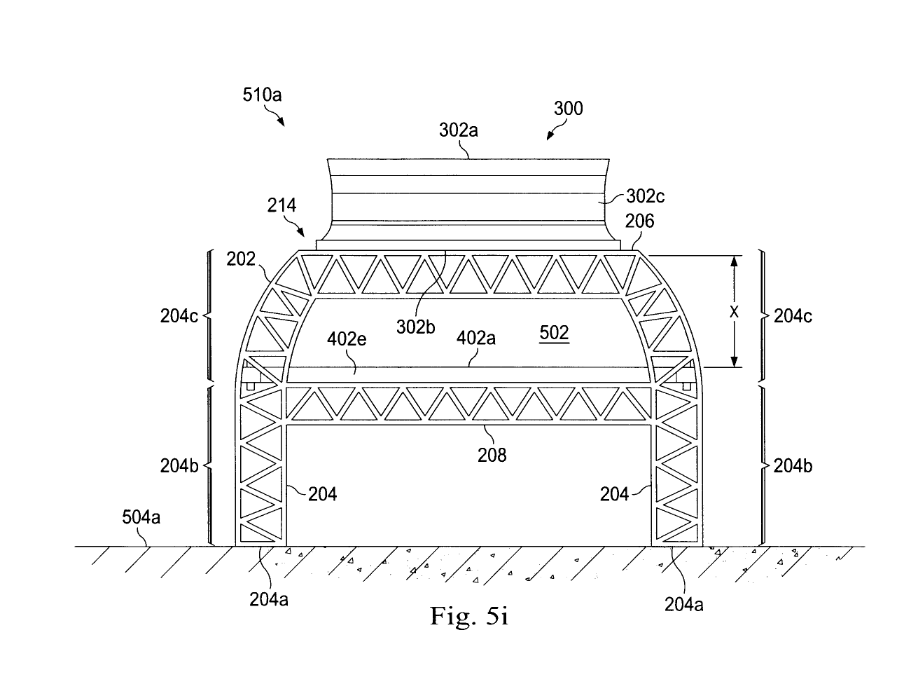

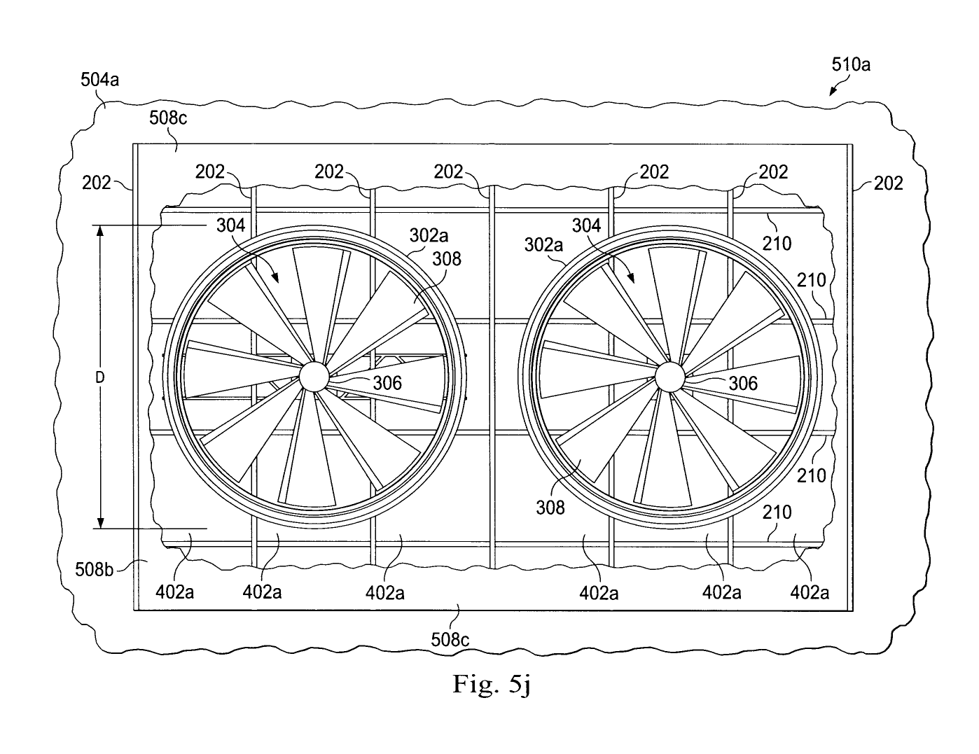

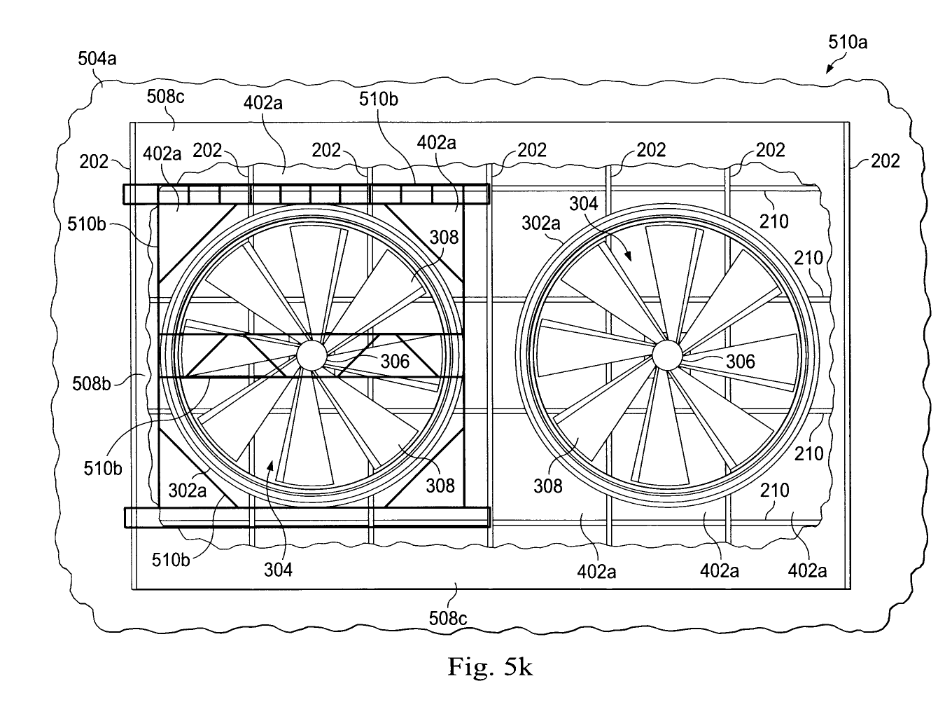

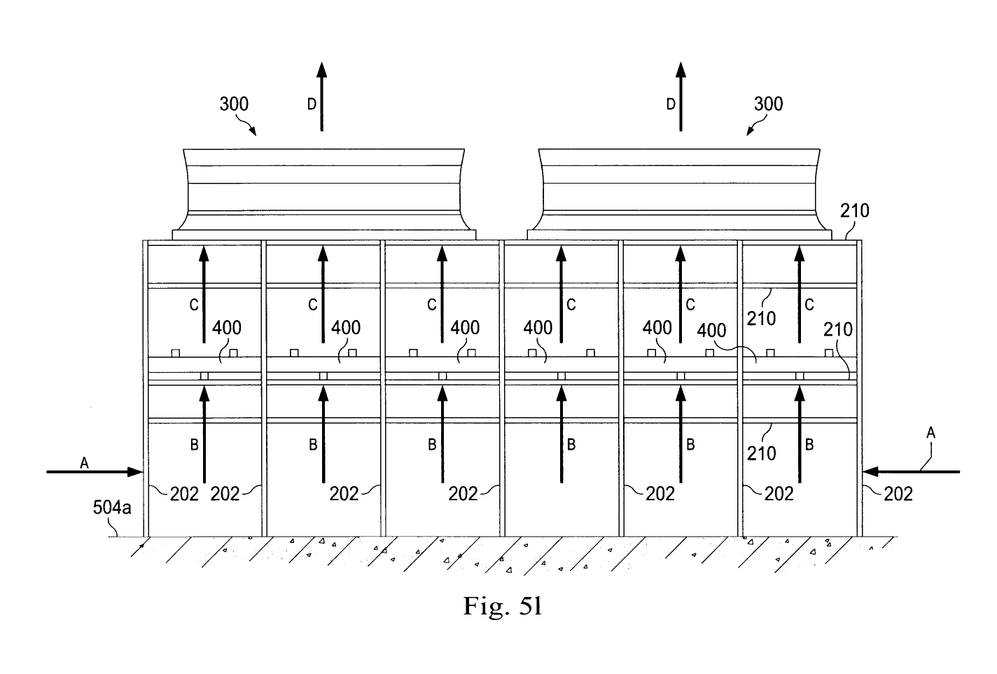

A plurality of condenser bundles (also called tube bundles or coil panels) are supported with the support structure 200. More specifically, a condenser bundle 400, described above with reference to FIGS. 4a, 4b, and 4c, is positioned on a condenser support structure 212 defined by the support structure 200 and oriented so that the bottom surface 402b condenser bundle 400 faces downward and is substantially parallel with and in a spaced apart orientation from the support surface 504a, as illustrated in FIGS. 5b and 5c, thereby forming an air intake for the air-cooled condenser system of the invention. A plurality of condenser bundles 400 may be supported side-by-side in this orientation by the support structure 200 in the same manner by positioning those condenser bundles 400 on respective condenser support structures 212 located between any two truss members 202, as illustrated in FIG. 5d. The condenser bundles 400 may then be fluidly coupled (e.g., through the inlets and outlets 404) to each other and/or to an evaporator, an expander, and a pump (e.g., the evaporator 102, the expander 104, and the pump 112 described above with reference to FIG. 1) in order to allow a working fluid to be cooled through the condensers 400, as described in further detail below. The fluid couplings between the condenser bundles 400 and other components of the power system have not been illustrated for clarity of discussion. In an embodiment, the condenser bundles 400 may be secured to the support structure 200 using securing methods known in the art.

In one preferred embodiment, an air plenum 502 between fan 300 and condenser bundle 400 may be formed. Preferably, plenum 502 is disposed between each fan 300 and its corresponding at least two condenser bundles 400 and forms a barrier to prevent air ingress into the system except through the air inlet of the condenser bundles. As shown in FIG. 5e, air plenum 502 may be constructed by securing a skin to the portion of truss members 202 extending between fan 300 and condenser bundle 400, both on the sides between adjacent leg truss member 204c as well as on the ends of the support structure. More specifically, a skin 508a is coupled to the support structure 200 such that the skin 508a extends between the opposing ends of the support structure 200, with a first section 508b located immediately adjacent the upper support frame 214, and two second sections 508c located immediately adjacent the arcuate sections 204c on the leg trusses 204, as illustrated in FIG. 5e. In an embodiment, the skin 508a may be secured to the support structure 200 using securing methods known in the art. In an embodiment, the first section 508b of the skin 508a defines a plurality of fan openings 508d that are located in a spaced apart orientation on the first section 508b of the skin 508a. In one embodiment, the skin 508a is a fabric material. In another embodiment, the skin 508a is flexible polymer membrane. In another embodiment, the skin 508a is a reinforced polymer covering. In another embodiment, skin 508a is lightweight sheet metal or other lightweight flexible material. While FIG. 5e illustrates only one condenser 400 being supported by the support structure 200, a plurality of condensers 400 may be supported by the support structure 200, as illustrated and described above with reference to FIG. 5d. In an embodiment, the skin 508a may include two third sections 508e that are coupled to the opposing ends of the support structure 200 and extend between the ends of the first section 508b and second sections 508c, as illustrated in FIG. 5e. In an embodiment, skin 508a may also be disposed internally on support structure 200 to form a barrier between adjacent fans. In other words, a section similar to section 508e may be disposed internally in structure 200 so that air flow between adjacent fans is not comingled, thereby reducing turbulence in the path of air flow through the system. In any event, as with the support structure 200, skin 508a is lightweight and easily installed on site during construction of the air-cooled condenser system of the invention. In this regard, skin 508a of plenum 502 may be installed before or after installation of fans 300 on support structure 200.

In order to minimize recirculation of warm air into the system, in one preferred embodiment, plenum 502 has a first end adjacent condenser bundles 400 and a second end adjacent fans 300. The first end of plenum 502 is characterized by a first perimeter length and the second end of plenum 502 is characterized by a second perimeter length. The second perimeter length is less than the first perimeter length so that plenum 502 narrows or necks down, as can be seen in FIG. 5i. In the embodiment, the first perimeter length is the perimeter around the side-by-side bundles served by a fan and the second perimeter is the perimeter of the fan housing those skilled in the art will appreciate that this corresponds to an air inlet for fan 300 that is smaller than the air outlet of bundle 400. In one preferred embodiment, the air outlet of the plenum is at least 10% smaller than the air inlet for the plenum.

A plurality of the fans 300, described above with reference to FIGS. 3a, 3b, and 3c, are positioned on the support structure 200 and, more specifically, supported by fan support frame 214, such that the bottom edges 302b of the fans 300 are located adjacent the fan openings 508d, as illustrated in FIGS. 5g, 5h, and 5i. In an embodiment, the fans 300 may be secured to the support structure 200 using securing methods known in the art. In an embodiment, each fan is located a distance X above the top surface 402a of the condenser bundles 400, as illustrated in FIG. 5i. In an embodiment, the distance X is at least 5 feet. In another embodiment, distance X is at least 10 feet and preferably 15-20 feet or more. In another embodiment, distance X is at least 8 feet and no more than 20 feet. Distance X is selected to permit a fan 300 to draw air across its associated at least two condenser bundles 400. Moreover, distance X corresponds with the height of the plenum 502. With the support structure 200, the condensers 300, and the fans 300 coupled together as illustrated in FIG. 5g, an air-cooled condenser system 510a is provided. FIGS. 5h and 5j illustrate the air-cooled condenser system 510a with a portion of the skin 508a removed to show that the fan diameter D is such that each fan 300 is located above at least a portion of two or more condenser bundles 400. In other words, the diameter D of the fan is selected to extend over a plurality of condenser bundles. In the illustrated embodiment, each fan 300 is located above more than at least half the width W of each of the three condenser bundles 400. In an embodiment illustrated in FIG. 5k, a fan support frame 510b is coupled to and/or secured to the fans 300 and/or the support structure 200 in order to provide additional support for the fans 300. The fan support frame 510b is only illustrated for one fan 300 for clarity of discussion, but may be used with both fans 300.

It has been found that the air cooled condenser system of the invention is particularly suitable for the large heat management requirements of ORC power plants to permit airflow to cool the organic working fluid of the power plant. As described above with reference to FIG. 1, a working fluid in the power system that is coupled to the air-cooled condenser system 510a may be pumped, heated, and expanded prior to being introduced to the air-cooled condenser system 510a. When introduced to the air-cooled condenser system 510a, the heated working fluid enters the condenser bundles 400. As shown in FIG. 51, the motors 306 in the fans 300 activate the fan members 308 which draw air into the system, shown as an airflow A, from outside the support structure 200. As mentioned above, the open cell nature of the leg trusses supporting the system promotes air flow into the system. Once in the system, the path of airflow through the system is substantially linear, truly promoting faster and more efficient cooling by minimizing turbulence. Specifically an airflow B is drawn through the condensers 400 to cool the working fluid in the condensers 400, becoming an airflow C that is linearly directed towards the fans 300, which then travels through the fans 300 and becomes an airflow D that is discharged from the system. The skin 508a forms a plenum that helps to direct the airflow discussed above. The shape of the fan housing 302 may be chosen to ensure that the maximum amount of airflow is directed through each condenser bundle 400. Furthermore, the spacing between the fans 300 and the inlet airflow B helps to prevent inefficiencies in the system that can result when hot outlet air recirculates back into the system. In essence, the comparatively large height X of the plenum permits exhaust air flow from the fans to be decoupled from the cooling air flow across the condenser bundles so as to minimizes the recirculation problems of the prior art. In an embodiment, the motors 306 are direct drive motors that eliminate the need for conventional belt drives, thus reducing the need for maintenance and replacement of belts.

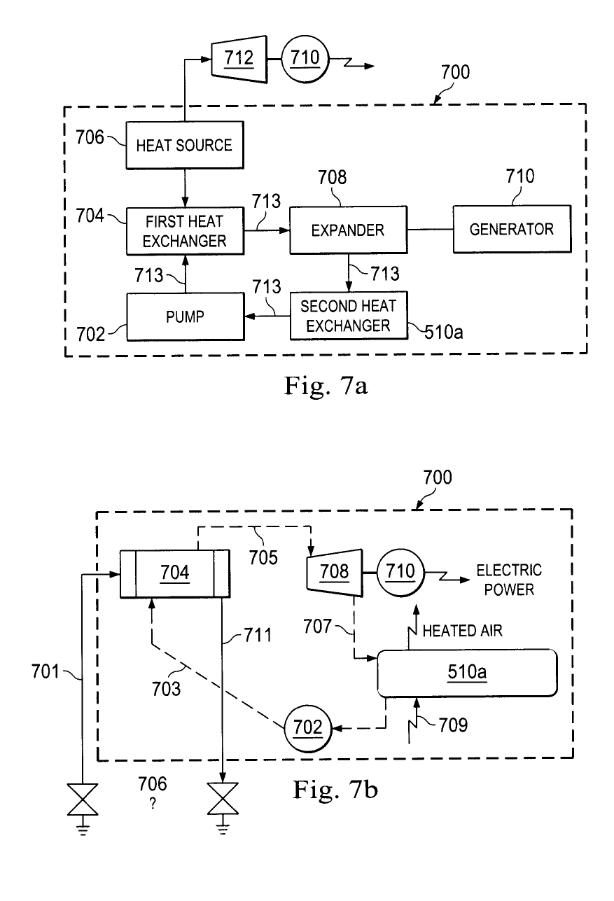

FIG. 7a illustrates the air cooled condenser system of the invention integrated with an ORC power plant. As shown, an ORC power plant 700 is comprised of a pump 702 that is operable to increase the pressure in an organic working fluid 713. A first heat exchanger system 704 is coupled to the pump and operable to supply heat to the organic working fluid. Preferably, the organic working fluid is selected from a group consisting of hydrocarbons (for example pentane and its isomers, butane and its isomers), halocarbons (for example R-134a, R-245fa, R1234yf), siloxanes, mixtures comprised of or incorporating one or more of the foregoing, ammonia water mixtures, ammonia or carbon dioxide. In any event, power plant 700 employs a source of heat 706 that may be derived from any waste heat, any renewable resource, or by the direct combustion of a fuel to provide heat to the first heat exchange system 704. An expander 708 is coupled to the first heat exchanger system 704 and is operable to expand the organic working fluid. Those skilled in the art will appreciate that expander 708 is in turn coupled to a generator 710 to produce electrical power. A second air-cooled heat exchanger system 510a is coupled to the expander 708 and operable to release heat from the organic working fluid and transfer the heat to the air flowing through heat exchanger 510a. In one embodiment, ORC power plant 700 may form a bottoming system which may be combined with a steam topping system having a steam turbine 712.

FIG. 7b illustrates the air cooled condenser system of the invention integrated with a geothermal ORC power plant. As shown, an ORC power plant 700 is comprised of a pump 702 that is operable to increase the pressure in an organic working fluid 703. A first heat exchanger system 704 is coupled to the pump 702 and operable to supply heat to the high pressure organic working fluid 703, thereby producing a high pressure organic working fluid vapor 705. The power plant 700 draws upon a heat source 706, which in this case is heated geothermal fluid 701, such as steam and/or brine, pumped from a geothermal reservoir which provides heat to the first heat exchange system 704. An expander 708 is coupled to the first heat exchanger system 704 and is operable to expand the high pressure organic working fluid vapor 705, thereby resulting in a low pressure organic working fluid vapor 707 exiting the expander 708. Those skilled in the art will appreciate that expander 708 is in turn coupled to a generator 710 to produce electrical power. A second air-cooled heat exchanger system 510a is coupled to the expander 708 and operable to release heat from the low pressure organic working vapor 707 and transfer the heat to the air 709 flowing through heat exchanger 510a. The heat depleted geothermal fluid 711 is them pumped back into the geothermal reservoir via an injection well(s).

Referring now to FIG. 5a, a method 500 for providing an air-cooled condenser system is illustrated. The method 500 begins at blocks 502 and 504, where a lightweight support structure is provided and engaged with a support surface. In an embodiment, the support structure is similar to support structure 200, described above with reference to FIGS. 2a, 2b, 2c, and 2d. The method 500 then proceeds to block 506 where a plurality of condensers bundles are supported with the support structure. The condenser bundles are arranged and positioned as described above with respect to condenser bundles 400. The condenser bundles 400 may then be fluidly coupled (e.g., through the inlets and outlets 404) to each other and to an evaporator, an expander, and a pump in order to allow a working fluid to be cooled through the condensers 400, as described above. The method 500 then proceeds to block 508 where a skin is extended between a plurality of the support structure truss members. The skin may be similar so skin 508a described above. The method 500 then proceeds to block 510 where a fan is supported with the support structure. The fan is supported so that it extends over at least two condenser bundles so as to be fluidly coupled to the at least two condenser bundles. The fan may be fan 300 as described above. The method 500 then proceeds to block 512 where airflow is provided to the condensers to cool a power system working fluid. As described above with reference to FIG. 1, a working fluid in the power system that is coupled to the air-cooled condenser system, such as system 510a, may be pumped, heated, and expanded prior to being introduced to the air-cooled condenser system. When introduced to the air-cooled condenser system 510a, the heated working fluid enters the condenser bundles 400 where air flow across the bundles from induced draft fans 300 cools the working fluid. The air travels through the system in a substantially linear travel path once entering the system.

While the above described system is preferably utilized with ORC power plants, it is equally suitable for other types of power plants where large banks of air cooled heat exchanges are required. This is particularly true of geothermal power plants.

As described above, the heat exchanger system of the invention is readily constructed on site at the industrial facility by delivering at least three heat exchanger bundles to a construction site at which a heat exchanger system is to be installed. None of the heat exchanger bundles are delivered with fans attached thereto, making transport and delivery of the individual components much simpler. Rather, the fans are delivered as separate, detached components. Once delivered, the trusses are arranged and secured for form a support structure. The heat exchanger bundles, i.e., the condenser bundles, are then arranged in substantially horizontal, side-by-side relationship above the ground on the truss structure. Fans are mounted above the heat exchanger bundles so that each fan extends over a portion of at least two and preferably at least three of the bundles. Finally, to enhance air flow and minimize recirculation effects, a substantially enclosed, elongated air plenum is formed between the fan and the bundles over which the fan extends.

Thus, an air-cooled condenser system has been described that includes an option for a prefabricated lightweight structural support components, but in all cases uses fewer and larger fans that are spaced further away from the condenser bundles than conventional systems. As an example, prior art air-cooled condensers for ORC plants would have a height from inlet of the condenser coil to the outlet of the fan plenum of approximately 4 to 9 feet in the direction of airflow (composed of approximately 2-3 feet of coil, 1-2 feet of plenum and 1-4 foot fan ring). The design of the invention greatly increase this separation between the inlet of the condenser bundle to the outlet of the fan plenum by often more than double the prior art designs. For example in one embodiment of the invention, the condenser bundle inlet to fan outlet separation is approximately 26 feet (composed of 2-3 feet of coil, 10 feet of plenum, and 14 feet of fan ring). The prefabricated lightweight components such as the truss members, beam members, and skin decrease the cost of shipping and assembly of the air-cooled condenser. The use of fewer larger fans fluidly coupled to more than one condenser bundle, along with the option of direct driving of those fans, provided for reduced fan-related maintenance costs. The larger fans and plenum, as well their orientation relative to the condenser bundles, provide improved airflow across the condenser bundles. The significant separation of the fans and the condenser bundles prevents hot exhaust from recirculating into the system. The optional prefabricated truss member allows the system to be quickly and easily fabricated onsite.

Another advantage of the invention is that it results in much fewer footings and less civil work on site when compared to the prefabricated units of the prior art. For a typical project, the system of the invention might have less than 25% of the footings as the typical prior art air-cooled condenser.

Modeling of the invention has confirmed that the air recirculation rate can be greatly reduced, and therefore the capacity of the ORC plant can be better maintained, regardless of wind speed and direction. As mentioned above, FIG. 1d. illustrates an air cooled condenser system of the prior art. FIG. 1e illustrates a front view of a modeled exhaust plenum from the FIG. 1 prior art cooler array, wherein the cross wind is blowing at 20 mph. This prior art array was modeled using a conventional arrangement array of thirty bundles with each bundle having 3 fans totaling 90 fans. Hot fluid that needs cooling is passed through the tube side of a heat exchanger. At the same time, ambient air enters the tube bank from below, passes over the outside of the tube bank, then exits the cooler through the three fans located on the top of the unit. Table 1 summarizes the results for the conventional array modeling.

TABLE 1
Summary of results for conventional cooler array.

| | 6 mph Wind Speed | | 20 mph Wind Speed | |
|---|---|---|---|---|
| Wind | Temperature | Recirculation | Temperature | Recirculation |
| Direction | (° F.) | (%) | (° F.) | (%) |
| North | 52.8 | 4.7 | 58.2 | 35.7 |
| Northeast | 54.3 | 13.0 | 52.4 | 2.3 |
| East | 53.0 | 5.8 | 52.1 | 0.7 |

The conventional cooler array experienced varying levels for recirculation for all three wind directions. Significant recirculation took place when the wind was aligned with the long axis of the array. As the wind speed increased, the amount of recirculation increased. This appears to be the result of the plume remaining closer to the ground as the wind speed increase. When the wind was at 45° and 90° to the long axis of the array, the amount of recirculation was higher with the 6 mph wind speed than with the 20 mph wind speed. This appears to be the result of the higher wind speed blowing the plume away from the array and that the higher wind speed forces cooler ambient air into the area below the intake of the cooler array, reducing the amount of exhaust recirculation.

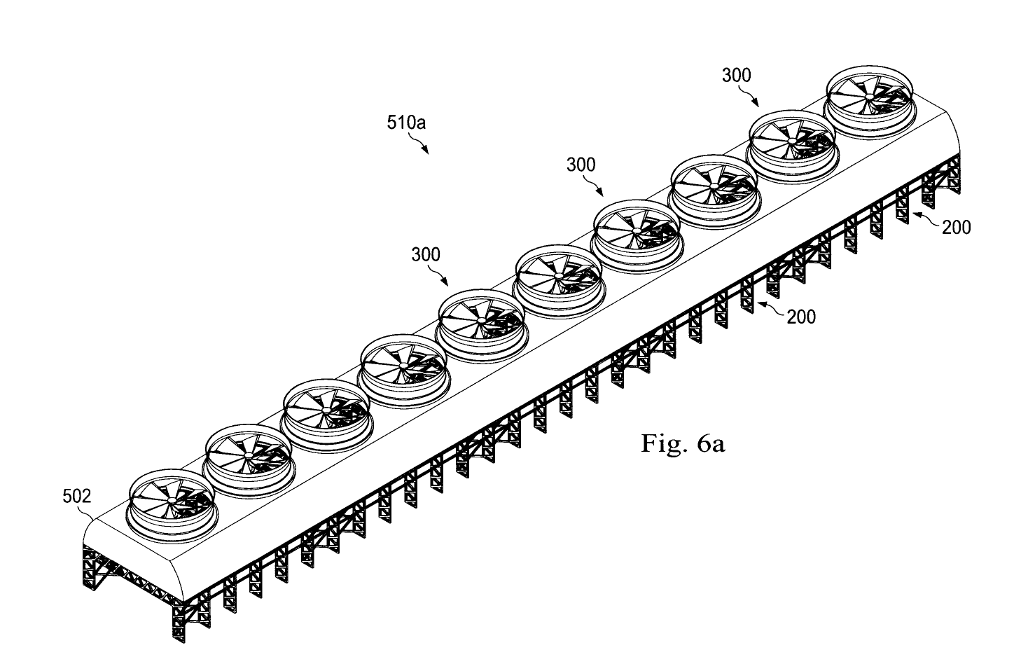

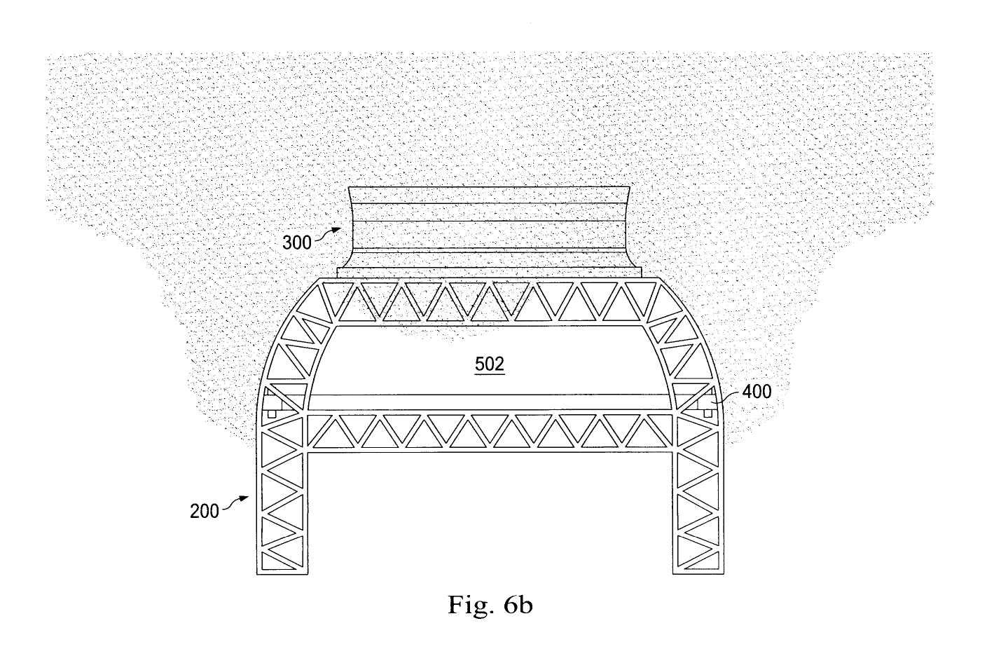

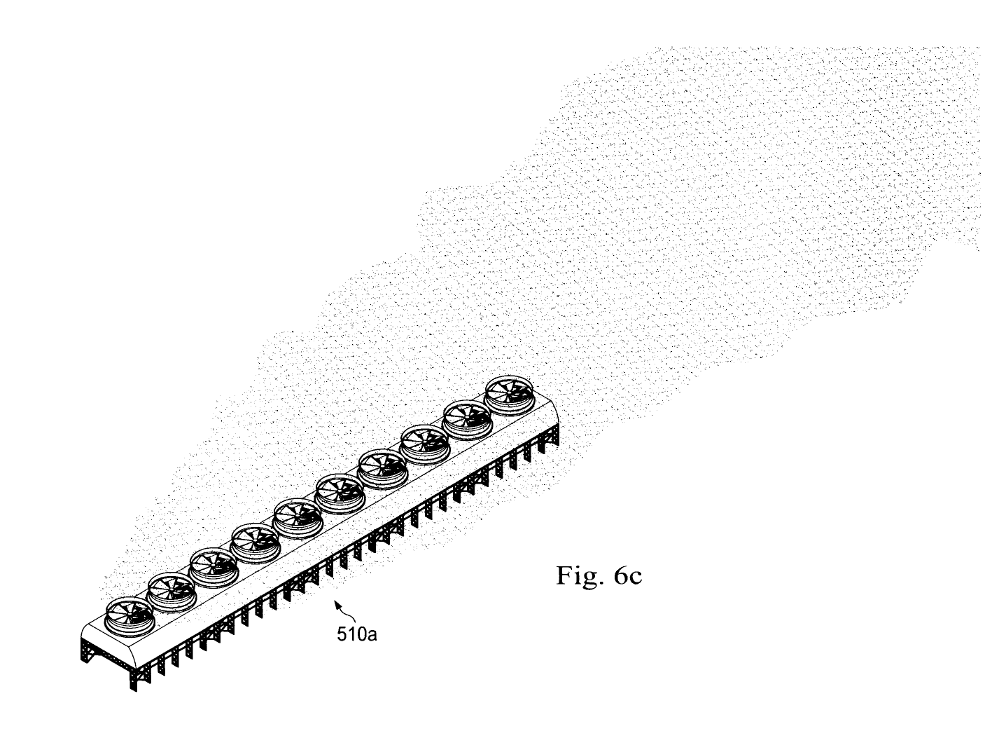

FIG. 6a, illustrates an air cooled condenser system of the invention as described above, and in particular, illustrates the geometry when compared to the prior art air cooled condenser of FIG. 1d. In FIGS. 6b and 6c, modeling of airflow of an air-cooled condenser system of the invention is shown, where the same array of thirty bundles as the example of prior art is shown. This example of the invention uses a single fan for every 3 bundles giving a total of just 10 fans. Table 2 summarizes the results for the modeling of the cooler array of the invention.

TABLE 2
Summary of results for TAS cooler array.

| | 6 mph Wind Speed | | 20 mph Wind Speed | |
|---|---|---|---|---|
| Wind | Temperature | Recirculation | Temperature | Recirculation |
| Direction | (° F.) | (%) | (° F.) | (%) |
| North | 52.0 | 0.0 | 52.2 | 1.2 |
| Northeast | 52.0 | 0.0 | 52.0 | 0.0 |
| East | 52.0 | 0.0 | 52.0 | 0.0 |

The cooler array of the invention experienced some recirculation when the wind was aligned with the long axis of the array when the wind speed was 20 mph, but no recirculation when the wind speed was 6 mph. There was no recirculation when the wind was at either 45° or 90° from the long axis of the array for either wind speed.

Thus, in one embodiment of the invention, a heat exchange system for industrial cooling comprises at least three elongated, heat exchange bundles, each elongated bundle disposed along a longitudinal axis and characterized by a length L and a width W; a support structure on which the heat exchanger bundles are mounted, said bundles mounted so that the longitudinal axis of the bundles are substantially parallel to one another and substantially horizontal; a substantially horizontal induced draft fan characterized by a diameter D and comprising a fan blade and a motor, the fan mounted above the heat exchanger bundles, wherein the diameter D of the fan is greater than the heat exchanger width W.

In another embodiment of the invention, a heat exchange system for industrial cooling comprises at least three elongated, flat bundles of heat exchange tubes, each elongated bundle disposed along a longitudinal axis and characterized by a length L and a width W; a support structure on which the heat exchanger bundles are mounted, said bundles mounted so that the longitudinal axis of the bundles are substantially parallel to one another and substantially horizontal; a substantially horizontal induced draft fan characterized by a diameter D, the fan mounted above the heat exchanger bundles and configured to draw air over said tubes, wherein the diameter D of the fan is greater than the heat exchanger width W.

In another embodiment of the invention, a heat exchange system for industrial cooling comprises at least three elongated, flat bundles of heat exchange tubes, each elongated bundle disposed along a longitudinal axis and characterized by a length L and a width W; a support structure on which the heat exchanger bundles are mounted, said bundles mounted so that the longitudinal axis of the bundles are substantially parallel to one another and substantially horizontal; at least two substantially horizontal induced draft fans each characterized by a diameter D, each fan mounted above at least two heat exchanger bundles and configured to draw air over said tubes, wherein the diameter D of each fan is greater than the heat exchanger width W.

In another embodiment of the invention, a heat exchanger for the transfer of heat from one fluid to another fluid comprises a plurality of heat exchanger bundles, horizontally disposed in a side-by-side relationship to one another; a plurality of induced draft fans disposed in a spaced apart relationship above the bundles, wherein there is less than one fan per heat exchanger bundle.

In a method for cooling a process fluid in a heat exchanger system, the following steps are provided for: driving at least one induced draft fan; delivering a heated process fluid through at least three side-by-side, substantially horizontally disposed heat exchanger bundles; and utilizing the induced draft fan to draw air across the at least three side-by-side, horizontally disposed heat exchanger bundles, thereby cooling the process fluid disposed within the bundles.

Other industrial processes that might be suitable for the air-cooled condenser system of the invention include refrigeration cycles were the process fluid is the discharge from a refrigeration compressor; a refinery, where the process fluid is a liquid or gas being manufactured at the refinery; a liquefied natural gas processing plant as part of either the liquefaction or gasification processes. Moreover, it is contemplated that the heat exchanger described for use with the system may be used to cool, among other things, the discharge from a gas compressor; a water based liquid; steam from the discharge from a steam turbine; or discharge from a turbine used in an organic Rankine cycle power plant.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. An Organic Rankine Cycle (ORC) power plant, comprising:
a pump that is operable to increase the pressure in an organic working fluid;
a first heat exchanger system that is coupled to the pump and operable to supply heat to the organic working fluid;
a source of heat to the first heat exchange system that may be derived from any waste heat, any renewable resource, or by the direct combustion of a fuel;
an expander that is coupled to the first heat exchanger and operable to expand the organic working fluid and is also coupled to a generator to produce electrical power; and
a second air-cooled heat exchanger system that is coupled to the expander and operable to release heat from the organic working fluid and transfer said heat to the air flowing through the heat exchanger, the second heat exchanger system comprising:
at least three elongated, heat exchange bundles, each elongated bundle disposed along a longitudinal axis and characterized by a length L and a width W;
a support structure on which the heat exchanger bundles are mounted, said bundles mounted so that the longitudinal axis of each of the bundles are substantially parallel to one another and substantially horizontal;
a substantially horizontal induced draft fan characterized by a diameter D, the fan mounted above the heat exchanger bundles, wherein the diameter D of the fan is greater than the heat exchanger bundle width W.

2. The system of claim 1, wherein the working fluid is selected from a group consisting of hydrocarbons, halocarbons, siloxanes, mixtures comprised of or incorporating one or more of the foregoing, ammonia water mixtures, ammonia and carbon dioxide.

3. The system of claim 1, wherein said tubes further comprise fins externally mounted thereon.

4. The system of claim 1, further comprising an air inlet and an air outlet, the air inlet disposed below the heat exchanger bundles and the air outlet disposed above the induced draft fan, wherein the distance between the air inlet and air outlet is at least 20 feet.

5. The system of claim 1, further comprising an air inlet and an air outlet, the air inlet disposed below the heat exchanger bundles and the air outlet disposed above the induced draft fan, wherein the distance between the air inlet and air outlet is at least 10 feet.

6. The system of claim 5, wherein the distance between the air inlet and air outlet is at least 15 feet.

7. The system of claim 1, wherein the diameter D of the fan is greater than at least twice the width W.

8. The system of claim 1, wherein the diameter D of the fan is greater than 150% of the width W.

9. The system of claim 1, wherein the fan extends over at least three bundles.

10. The system of claim 1, wherein the fan is spaced apart from the top of the heat exchanger bundles by at least 5 feet.

11. The system of claim 1, wherein said fan is a direct drive fan.

12. The system of claim 1, further comprising a fan motor, said fan further comprising a hub on which a fan blade is mounted, a spindle to which the hub is attached and said fan motor is directly linked to said spindle.

13. The system of claim 1, further comprising a fan motor and a gearbox, said fan further comprising a hub on which a fan blade is mounted, a spindle to which the hub is attached, wherein said gearbox is attached between said motor and said spindle.

14. The system of claim 13, wherein said fan is linked via a gear box to the output shaft of the fan motor.

15. The system of claim 1, further comprising a plenum formed between the fan and the substantially horizontal bundles, the plenum forming an enclosed air passage that extends between the spaced apart fan and the bundles and is a barrier to the entry of outside air into the plenum.

16. The system of claim 15, wherein the plenum is characterized by a height H.

17. The system of claim 16, wherein the plenum height H is at least 4 feet.

18. The system of claim 16, wherein the plenum height H is at least 8 feet and no more than 20 feet.

19. The system of claim 15, wherein the barrier is a skin of fabric material or a flexible polymer membrane.

20. The system of claim 15, wherein the barrier is a skin of flexible material or flexible sheet metal.

21. The system of claim 15, wherein the plenum is characterized by a lower portion adjacent the bundles and having a first perimeter length and an upper portion adjacent the fan and having a second perimeter length less than the first perimeter length.

22. The system of claim 15, wherein the plenum is characterized by having a substantially horizontal air inlet positioned above the bundles and a substantially horizontal air outlet positioned adjacent the fan.

23. The system of claim 22, wherein the air outlet is at least 10% smaller than the air inlet.

24. The system of claim 1, wherein the support structure comprises a plurality of truss members.

25. The system of claim 24, wherein said truss members are coupled together in a spaced apart orientation by a plurality of beam members to define heat exchanger bundle bracing between any two truss members, wherein each of the plurality of truss members includes a pair of legs that engage a support surface.

26. The system of claim 25, wherein a first set of said truss members are arranged to support the heat exchanger bundles and a second set of truss members are arranged to support the fan.

27. The system of claim 1, wherein the support structure comprises a first set of outside structural elements supported by a smaller set of intermediate structural elements.

28. The system of claim 27, wherein the first set of structural elements is one of at least a plurality of beams, columns, angle braces, or arches.

29. The system of claim 1, wherein the support structure comprises a plurality of substantially identical beam members, wherein a first set of said beam members are arranged to support the heat exchanger bundles and a second set of beam members are arranged to support the fan.

30. The system of claim 1, wherein the fan motor is disposed to operate at less than 250 RPMs and has a power output of greater than 25 HP, the fan diameter D is greater than 15 feet, the bundle length L is greater than 40 feet and the bundle width is greater than 8 feet.

31. The system of claim 1, wherein the fan motor is disposed to operate at less than 200 RPMs and has a power output of greater than 25 HP, the fan diameter D is greater than 20 feet,

32. The system of claim 1, wherein the bundle length L is greater than 40 feet and the bundle width is greater than 8 feet.

33. The system of claim 1, wherein said bundle length L is at least 60 feet.

34. The system of claim 1, wherein said bundle width W is at least 10 feet.

35. The system of claim 1, wherein said heat exchanger bundles each comprise a plurality of externally finned heat exchanger tubes longitudinally extending substantially along the length of the bundle.

36. The system of claim 35, wherein said heat exchanger bundles each comprise a first header having first and second fluid ports in fluid communication with the tubes.

37. The system of claim 35, wherein said heat exchanger bundles each comprise a first header and a second header, each header having first and second fluid ports in fluid communication with the tubes.

38. A geothermal power plant, comprising:
a steam topping system comprising:
a steam turbine;
an Organic Rankin Cycle (ORC) bottoming system comprising:
a pump that is operable to increase the pressure in an organic working fluid;
a first heat exchanger system that is coupled to the pump and operable to supply heat to the organic working fluid;
a source of geothermal heat which may be either separated steam, steam discharged from a steam turbine, or separated geothermal brine,
an expander that is coupled to the first heat exchanger system and operable to expand the organic working fluid and is also coupled to a generator to produce electrical power; and
an air-cooled condenser system comprising:
a second heat exchanger system that is coupled to the expander and operable to release heat from the organic working fluid by transferring said heat to the air passing through the heat exchanger system, the second heat exchanger system comprising:
at least three elongated, heat exchange bundles, each elongated bundle disposed along a longitudinal axis and characterized by a length L and a width W;
a support structure on which the heat exchanger bundles are mounted, said bundles mounted so that the longitudinal axis of each of the bundles are substantially parallel to one another and substantially horizontal;
a substantially horizontal induced draft fan comprising a fan blade and a motor, the fan mounted above the at least three heat exchanger bundles, wherein the diameter of the fan is greater than the heat exchanger bundle width.

39. The geothermal power plant of claim 38, further comprising at least one separator capable of separating geothermal fluid into a first stream of substantially steam and a second stream of substantially liquid.

40. A method of constructing and operating an ORC power plant, said method comprising:
providing a pump, a first heat exchanger system, an expander, a second heat exchanger system and a working fluid;
supporting at least two elongated, side-by-side heat exchanger bundles in a substantially horizontal position;
supporting a fan above and in a spaced apart orientation from the two or more heat exchanger bundles,
increasing the pressure of the working fluid with the pump;
heating the working fluid with the first heat exchanger system;
expanding the working fluid across the expander;
directing the expanded working fluid into the heat exchanger bundles;
utilizing the fan to draw air across the at least two heat exchanger bundles with the air being drawn from below the heat exchanger bundles, thereby cooling the working fluid disposed in the bundles;
passing the air used to cool the working fluid through a substantially enclosed plenum formed between the fan and the heat exchanger bundles;
discharging air used to cool the working fluid at a location above the air intake.

41. The method of claim 40, wherein the fan is utilized to draw air across at least three side-by-side, horizontal heat exchanger bundles.

42. The system of claim 40, wherein the step of driving is accomplished by directly coupling the shaft a motor to the drive shaft of the fan.

43. A geothermal power plant, comprising:
an Organic Rankin Cycle (ORC) system comprising:
a pump that is operable to increase the pressure in an organic working fluid;
a first heat exchanger system that is coupled to the pump and operable to supply heat to the organic working fluid;
a source of geothermal heat supplied by pressurized geothermal brine pumped from the ground directly to the geothermal power plant,
an expander that is coupled to the first heat exchanger system and operable to expand the organic working fluid and is also coupled to a generator to produce electrical power; and
an air-cooled condenser system comprising:
a second heat exchanger system that is coupled to the expander and operable to release heat from the organic working fluid by transferring said heat to the air passing through the heat exchanger system, the second heat exchanger system comprising:
at least three elongated, heat exchange bundles, each elongated bundle disposed along a longitudinal axis and characterized by a length L and a width W;
a support structure on which the heat exchanger bundles are mounted, said bundles mounted so that the longitudinal axis of each of the bundles are substantially parallel to one another and substantially horizontal;
a substantially horizontal induced draft fan comprising a fan blade and a motor, the fan mounted above the three or more heat exchanger bundles, wherein the diameter of the fan is greater than the heat exchanger bundle width.
